(19) United States
(12) Patent Application Publication
(10) Pub. No.: US 2003/0199609 A1
(43) Pub. Date: Oct. 23, 2003

(54) Ink composition and image-forming method using the same

(76) Inventors: Junichi Yamanouchi, Kanagawa (JP); Takahiro Ishizuka, Kanagawa (JP); Kazue Sano, kanagawa (JP)

Correspondence Address: BURNS, DOANE, SWECKER & MATHIS, L.L.P., P.O. Box 1404, Alexandria, VA, 22313-1404, US

(21) Appl. No.: 10/352,883

(22) Filed: Jan. 29, 2003

(30) Foreign Application Priority Data
Jan. 30, 2002 (JP) 2002-21721

(51) Int. Cl. C03C 17/00; C09D 5/00

(52) U.S. Cl. 523/160; 523/161

(57) ABSTRACT

An ink composition comprising an aqueous medium having dispersed therein a coloring fine particle dispersion, wherein the coloring fine particle dispersion contains a hydrophobic ethylenically unsaturated monomer and at least one oil-soluble dye, and the ink composition contains apolymerization initiator.

### FIELD OF THE INVENTION

The present invention relates to a coloring fine particle dispersion of aqueous system, an ink composition containing the coloring fine particle dispersion, and an image-forming method using the same. The present invention more specifically relates to a coloring fine particle dispersion which provides a high quality recorded image, is excellent in jetting stability, and is suitable as the water color ink for writing, the water color ink for printing and the ink for data-recording, an ink composition suitable for thermal, piezoelectric, electric field and acoustic ink jet systems, and an image-forming method.

### BACKGROUND OF THE INVENTION

With the spread of computer in recent years, ink jet printers are widely used not only in offices but also in homes for printing on paper, film and cloth. As the compositions of inks, oil, aqueous and solid state inks are known, but water color inks are mainly used from the points of manufacturing, handling, odor and safety.

However, since water-soluble dyes which are dissolved in a molecular state are used in many of the water color inks, although they have advantages such that transparency and color density are high, inferior in water resistance and cause bleeding when printed on plain paper and printing quality is conspicuously degraded since the dyes are water-soluble, and also poor in light fastness.

For the purpose of solving the above problems, water color inks in which pigments and dispersed dyes are used are suggested, e.g., in JP-A-56-157468 (the term “JP-A” as used herein means an “unexamined published Japanese patent application”), JP-A-4-18468, JP-A-8-183920, JP-A-10-110126 and JP-A-10-195355. However, in the case of these water color inks, water resistance can be improved in a certain degree but not sufficient, and dispersion of pigments and dispersed dyes lack the storage stability in the water color inks, which is liable to cause clogging at a jet.

Further,. it has. been found that when a recording paper provided on the surface thereof with an ink-receiving layer containing a porous inorganic pigment (a so-called paper for photographic image quality) is used, which paper has come to be used with a rise in tendency to make a high image quality of the ink jet technique, the water color ink containing the pigments and the dispersed dyes permeate the paper with difficulty, and the pigments are liable to be peeled off from the surface of paper when rubbed by hand.

Further, methods of incorporating a dye into dispersed particles of acrylic polymer, polyurethane or polyester are disclosed in JP-A-58-45272, JP-A-6-340825, JP-A-7-268254, JP-A-7-268257, JP-A-7-268260, JP-A-10-279873 and JP-A-11-286637.

However, these dispersions have drawbacks that coloring particles excellent in dispersion stability are difficult to obtain when a dye is incorporated in desired concentration, and peeling of a dye occurs the same as above.

On the other hand, British Patent 2,314,851 discloses a UV-curable ink jet ink which comprises polymerizable acrylate, a colorant and an UV ray initiator and is excellent in adhesion with plastic base materials. However, all the colorants disclosed in the above patent are dispersions of pigments and the tones of the images to be obtained are not sufficient. Further, there arise problems that the dispersibility of a dye becomes unstable according to the polymerizable acrylate. to be selected, and also ink is liable to agglomerate.

### SUMMARY OF THE INVENTION

The objects of the present invention are to provide an ink composition which is excellent in handleability, safety and dispersion stability of coloring fine particles, is not dependent on the base material, is excellent in coloring property and tone when printed on an arbitrarily selected base material, is satisfactory in water resistance and light fastness, is free of stains just after printing, and is excellent in the stability of dye with aging of ink, and to provide an image-forming method. In particular, the objects of the present invention are to provide an ink composition which is excellent in permeation of ink when printed on a paper, is free of stains just after printing, and is excellent in water resistance and light fastness, and to provide an image-forming method.

The means to solve the above objects and the preferred embodiments are as follows. (1) An ink composition comprising an aqueous medium having dispersed therein a coloring fine particle dispersion, wherein the coloring fine particle dispersion contains a hydrophobic ethylenically unsaturated monomer and at least one oil-soluble dye, and the ink composition contains a polymerization initiator. (2) The ink composition as described in the above item (1) , wherein the oil-soluble dye is represented by the following formula (I):

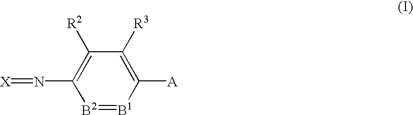

wherein X represents the residue of a color photographic coupler; A represents —NR⁴R⁵or a hydroxyl group; R⁴ and R⁵each represents a hydrogen atom, an aliphatic group, an aromatic group, or a heterocyclic group; B¹ represents ═C(R⁶)—or ═N—; B² represents —C(R⁷)═or —N═; R², R³, R⁶ and R⁷ each represents a hydrogen atom, a halogen atom, an aliphatic group, an aromatic group, a heterocyclic group, a cyano group, —OR⁵¹, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹or —NR⁷⁰SO₂NR⁷⁰R⁵¹, R⁵², R⁵³, R⁵⁴, R⁵⁵, R⁵⁶,R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰, R⁷¹, each represents a hydrogen atom, an aliphatic group or an aromatic group; and R² and R³, R³ and R⁴, R⁴ and R⁵, R⁵ and R⁶, and R⁶ and R⁷ may be bonded to each other to form a ring. (3) The ink composition as described in the above item (1) or (2) , wherein the content of the hydrophobic ethylenically unsaturated monomer in the coloring fine particles is 25 mass % or more. (4) The ink composition as described in any of the above items (1) to (3), wherein the polymerization initiator is contained in the coloring fine particles. (5) The ink composition as described in any of the above items (1) to (4), wherein the polymerization initiator is an initiator which generates radicals by heating or ultraviolet irradiation. (6) The ink composition as described in any of the above items (1) to (5), wherein the boiling point of the hydrophobic ethylenically unsaturated monomer is 150° C. or higher.

(7) The ink composition as described in any of the above items (1) to (6), wherein the average particle diameter of the coloring fine particles in the coloring fine particle dispersion is 500 nm or less.

(8) The ink composition as described in any of the above items (1) to (7) which has viscosity of 10 mpa.s or less.

(9) An image-forming method comprising the steps of printing by using the ink composition as described in any of the above items (1) to (8) and then polymerizing the hydrophobic ethylenically unsaturated monomer.

(10) The image-forming method as described in the above item (9) , wherein the image-receiving material to be recorded comprises a support having thereon an ink-receiving layer containing a porous inorganic pigment.

(11) A manufacturing method of the ink composition as described in the above item (1) which comprises the step of obtaining a coloring fine particle dispersion by emulsification dispersing a solution containing a hydrophobic ethylenically unsaturated monomer and at least one oil-soluble dye in an aqueous medium.

### DETAILED DESCRIPTION OF THE INVENTION

Ink Composition:

The ink composition according to the present invention is described below. The ink composition in the present invention comprises a coloring fine particle dispersion containing a hydrophobic ethylenically unsaturated monomer and at least one oil-soluble dye, and a polymerization initiator.

Coloring fine Particle Dispersion:

The coloring fine particle dispersion is described.

The coloring fine particle dispersion in the present invention is a substance comprising a polymerizable ethylenically unsaturated monomer and at least an oil-soluble dye, dispersed in an aqueous medium.

More specifically describing, the coloring fine particle dispersion in the present invention is a substance comprising a polymerizable ethylenically unsaturated monomer and an oil-soluble dye having dispersed in an aqueous medium as fine particles of oil droplets in an emulsified state.

Further, “an aqueous medium” in the present invention means water or the mixture of water and a small amount of water-miscible organic solvent containing, according to necessity, additives, e.g., a surfactant, a wetting agent, a stabilizer, an antiseptic, etc.

Oil-soluble Dye:

The oil-soluble dye contained in the coloring composition is described.

Of the oil-soluble dyes which can be used in the present invention, arbitrary dyes can be used as yellow dyes. For example, aryl or heteryl azo dyes having, e.g., phenols, naphthols, anilines, pyrazolones, pyridones, or open chain type active methylene compounds as the coupling component; azomethine dyes having, e.g., open chain type active methylene compounds as the coupling component; methine dyes, e.g., benzylidene dyes and monomethine oxonol dyes; and quinone series dyes, e.g., naphthoquinone dyes and anthraquinone dyes, are exemplified. As other dyes besides the above, quinophthalone dyes, nitro/nitroso dyes, acridine dyes and acridinone dyes are exemplified.

Of the oil-soluble dyes which can be used in the present invention, arbitrary dyes can be used as magenta dyes. For example, aryl or heteryl azo dyes having, e.g., phenols, naphthols or anilines as the coupling component; azomethine dyes having, e.g., pyrazolones or pyrazolotriazoles as the coupling component; methine dyes, e.g., arylidene dyes, styryl dyes, merocyanine dyes and oxonol dyes; carbonium dyes, e.g., diphenylmethane dyes, triphenylmethane dyes, and xanthene dyes; quinone series dyes, e.g., naphthoquinone dyes, anthraquinone dyes, and anthrapyridone dyes; and condensed polycyclic series dyes, e.g., dioxazine dyes are exemplified.

Of the oil-soluble dyes which can be used in the present invention, arbitrary dyes can be used as cyanine dyes. For example, indoaniline dyes, indophenol dyes, and azomethine dyes having, e.g., pyrrolotriazoles, as the coupling component; polymethine dyes, e.g., cyanine dyes, oxonol dyes, and merocyanine dyes; carbonium dyes, e.g., diphenylmethane dyes, triphenylmethane dyes, and xanthene dyes; phthalocyanine dyes; anthraquinone dyes; aryl or heteryl azo dyes having, e.g., phenols, naphthols or anilines as the coupling component; and indigo/thioindigo dyes are exemplified.

Each of these dyes may be a dye which turns yellow, magenta or cyan after a part of the chromophore of which is dissociated. The counter cationsin such a case may be inorganic: cations, e.g., alkali metals or ammonium, or may be organic cations, e.g., pyridinium or quaternary ammonium salts, or may be polymer cations having these cations as the partial structure.

The preferred specific examples of these oil-soluble dyes include the following dyes but the present invention is not limited to these dyes.

For example, C.I. solvent black 3, 7, 27, 29 and 34; C.I. solvent yellow 14, 16, 19, 29, 30, 56, 82, 93 and 162; C.I. solvent red 1, 3, 8, 18, 24, 27, 43, 49, 51, 72, 73, 109, 122, 132 and 218; C.I. solvent violet 3; C.I. solvent blue 2, 11, 25, 35 and 70; C.I. solvent green 3 and 7; and C.I. solvent orange 2 are preferably used.

Of these, the more preferred examples are Nubian Black PC-0850, Oil Black HBB, Oil Yellow 129, Oil Yellow 105, Oil Pink 312, Oil Red 5B, Oil Scarlet 308, Vali Fast Blue 2606, and Oil Blue BOS (manufactured by Orient Kagaku Kogyo Co., Ltd.), Neopen Yellow 075, Neopen Mazenta SE1378, Neopen Blue 808, Neopen Blue FF4012, Neopen Cyan FF 4238 (manufactured by FASF Co.).

Dispersed dyes can also be used in the present invention in the range of being dissolved in water-immiscible organic solvents, and the preferred specific examples of such dyes are shown below but the present invention is not limited to these dyes.

For example, C.I. disperse yellow 5, 42, 54, 64, 79, 82, 83, 93, 99, 100, 119, 122, 124, 126, 160, 184:1, 186, 198, 199, 201, 204, 244 and 237; C.I. disperse orange 13, 29, 31:1, 33, 49, 54, 55, 66, 73, 118, 119 and 163; C.I. disperse red 54, 60, 72, 73, 86, 88, 91, 92, 93, 111, 126, 127, 134, 135, 143, 145, 152, 153, 154, 159, 164, 167, 177, 181, 204, 206, 207, 221, 239, 240, 258, 277, 278, 283, 311, 323, 343, 348, 356 and 362; C.I. disperse violet 33; C.I. disperse blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and C.I. disperse green 6:1 and 9 are preferably used.

Further, of the above oil-soluble dyes, dyes which are formed from couplers and developing agents in color photographic materials by oxidation are preferred, and among such dyes, a compound represented by the following formula (I) (sometimes referred to as “the dye of the present invention”) is more preferred.

A compound represented by formula (I) is described below. A compound represented by formula (I) in which at least one group represents the following-shown preferred range is preferred, a compound in which more groups represent the preferred ranges is more preferred, and a compound in which every group represents the preferred range is particularly preferred.

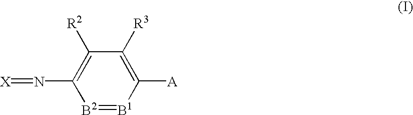

In formula (I), X represents the residue of a color photographic coupler; A represents —NR⁴R⁵ or a hydroxyl group; R⁴ and R⁵ each represents a hydrogen atom, an aliphatic group, an aromatic group, or a heterocyclic group.

A preferably represents —NR⁴R⁵. R⁴ and R⁵each preferably represents a hydrogen atom or an aliphatic group, more preferably represents a hydrogen atom, an alkyl group or a substituted alkyl group, and particularly preferably represents a hydrogen atom, an alkyl group having from 1 to 18 carbon atoms, or a substituted alkyl group having from 1 to 18 carbon atoms.

In formula (I), B¹ represents ═C(R⁶)—or ═N—; B² represents —C (R⁷)═or —N═. B¹ and B² preferably do not represent —N═at the same time, and more preferably B¹ represents ═C(R6)— and B2 represents —C(R⁷)═.

In formula (I),R², R³, R⁶and R⁷ each represents a hydrogen atom, a halogen atom, an aliphatic group, an aromatic group, a heterocyclic group, a cyano:group,

—OR⁵, —SR⁵², —CO₂R⁵³, —OCOR⁵⁴, —NR⁵⁵R⁵⁶, —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹ or —NR⁷⁰SO₂R⁷¹.

R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰ and R⁷¹ each represents a hydrogen atom, an aliphatic group or an aromatic group.

Of these, R² and R⁷ each preferably represents a hydrogen atom, a halogen atom, an aliphatic group, —OR⁵¹, —NR⁶²CONR⁶³R , —NR⁶⁵CO₂R⁶⁶, —NR⁶⁸COR⁶⁹ or —NR⁷⁰SO₂R⁷¹, more preferably represents a hydrogen atom, a fluorine atom, a chlorine atom, an alkyl group, a substituted alkyl group, —NR⁶²CONR⁶³R⁶⁴ or —NR⁶⁸COR⁶⁹, particularly preferably represents a hydrogen atom, a chlorine atom, an alkyl group having from 1 to 10 carbon atoms, or a substituted alkyl group having from 1 to 10 carbon atoms, and most preferably represents a hydrogen atom, an alkyl group having from 1 to 4 carbon atoms, or a substituted alkyl group having from 1 to 4 carbon atoms.

Of these, R³ and R⁶ each preferably represents a hydrogen atom, a halogen atom, or an aliphatic group, more preferably represents a hydrogen atom, a fluorine atom, a chlorine atom, an alkyl group, or a substituted alkyl group, particularly preferably represents a hydrogen atom, a chlorine atom, an alkyl group having from 1 to 10 carbon atoms, or a substituted alkyl group having from 1 to 10 carbon atoms, and most preferably represents a hydrogen atom, an alkyl group having from 1 to 4 carbon atoms, or a substituted alkyl group- having from 1 to 4 carbon atoms.

In formula (I), R² and R³, R³ and R⁴, R⁴ and R⁵, R⁵ and R⁶, and R⁶ and R⁷ may be bonded to each other to form a ring.

As the combinations of forming a ring, the combinations of R³ and R⁴, R⁴ and R⁵, and R⁵ and R⁶ are preferred.

As the ring formed by R² and R³, or R⁶ and R⁷ by bonding to each other, a 5- or 6-membered ring is preferred. As the examples of the rings, an aromatic ring (e.g., a benzene ring, etc.) and an unsaturated heterocyclic ring (e.g., a pyridine ring, an imidazole ring, a thiazole ring, a pyrimidine ring, a pyrrole ring, a furan ring, etc.) are preferred.

As the ring formed by R³ and R⁴₁ or R⁵ and R⁶ by bonding to each other, a 5- or 6-membered ring is preferred. As the examples of the rings, a tetrahydroquinoline ring and a dihydroindole ring are preferred.

As the ring formed by R4 and R by bonding to each other, a 5- or 6-membered ring is preferred. As the examples of the rings, a pyrrolidine ring, a piperidine ring and a morpholine ring are preferred.

In the specification of the present invention, an aliphatic group means an alkyl group, a substituted alkyl group, an alkenyl group, a substituted alkenyl group, an alkynyl group, a substituted alkynyl group, an aralkyl group and a substituted aralkyl group.

The alkyl group may .be branched or cyclic. The carbon atom number in the alkyl group is preferably from 1 to 20, and more preferably from 1 to 18.

The alkyl moiety in the substituted alkyl group is the same as in the case of the above alkyl group.

The alkenyl group may be branched or cyclic. The carbon atom number in the alkenyl group is preferably from 2 to 20, and more preferably from 2 to 18.

The alkenyl moiety in the substituted alkenyl group is the same as in the case of the above alkenyl group.

The alkynyl moiety in the substituted alkynyl group is the same as in the case of the above alkynyl group.

The alkyl moiety in the aralkyl group and the substituted aralkyl group is the same as in the case of the above alkyl group.

The aryl moiety in the aralkyl group and the substituted aralkyl group is the same as in the case of the following aryl group.

As the substituents of the alkyl moieties in the above substituted alkyl group, substituted alkenyl group, substituted alkynyl group, and substituted aralkyl group, e.g., a halogen atom, a cyano group, a nitro group, a heterocyclic group, —OR¹¹¹, —SR ¹¹², —CO₂R¹¹³, —NR¹¹⁴R¹¹⁵, CONR¹¹⁶R¹¹⁷ —SO₂R¹¹⁸, and —SO₂NR¹¹⁹R¹²⁰ are exemplified.

R¹¹¹, R¹¹², R¹¹³ , R¹¹⁴, R¹¹⁵, R¹¹⁶, R¹¹⁷, R¹¹⁸, R¹¹⁹, and R¹²⁰ each represents a hydrogen atom, an aliphatic group or an aromatic group.

As the substituents of the aryl moiety in the above substituted aralkyl group, the same examples of the substituents as in the following substituted aryl group are exemplified.

In the specification of the present invention, an aromatic group means an aryl group and a substituted aryl group.

The aryl group is preferably a phenyl group or a naphthyl group, and more preferably a phenyl group.

The aryl moiety in the substituted aryl group is the same as in the case of the above aryl group.

As the substituents of the above substituted aryl group, e.g., a halogen atom, a cyano group, a nitro group, an aliphatic group, a heterocyclic group, —OR¹²¹, —SR¹²², —CO₂R¹²³, —NR¹²⁴R¹²⁵, —CONR¹²⁶R¹²⁷, —SO₂R¹²⁸, and —SO₂NR¹²⁹R¹³⁰ are exemplified.

R¹²¹, R¹²², R¹²³, R¹²⁴, R¹²⁵, R¹²⁶, R¹²⁷, R¹²⁸, R¹²⁹ and R¹³⁰ each represents a hydrogen atom, an aliphatic group or an aromatic group.

In the specification of the present invention, a heterocyclic group includes both groups having a saturated heterocyclic ring and an unsaturated heterocyclic ring. The heterocyclic ring is preferably a 5- or 6-membered ring. An aliphatic ring, an aromatic ring or other heterocyclic rings may be condensed to the heterocyclic ring.

As the hetero atoms in the heterocyclic ring, e.g., a boron atom, a nitrogen atom, an oxygen atom, a sulfur atom, a selenium atom and a tellurium atom are exemplified. Of these hetero atoms, a nitrogen atom, an oxygen atom and a sulfur atom are preferred.

Of the atoms constituting the heterocyclic ring, heterocyclic groups having a carbon atom having a free valence (monovalence) (the heterocyclic group is bonded via a carbon atom) are preferred.

As the saturated heterocyclic rings, e.g., a pyrrrolidine ring, a morpholine ring, a 2-bora-1,3-dioxolan ring and a 1,3-thiazolidine ring are exemplified.

As the unsaturated heterocyclic rings, e.g., an imidazole ring, a thiazole ring, a benzothiazole ring, a benzoxazole ring, a benzotriazole ring, a benzoselenazole ring, a pyridine ring, a pyrimidine ring and a quinoline ring are exemplified.

The heterocyclic group may have a substituent. As the examples of the substituents, e.g., a halogen atom, a cyano group, a nitro group, an aliphatic group, an aromatic group, a heterocyclic group,

—OR¹³¹, —SR¹³², —CO₂R¹³³, —NR¹³⁴R¹³⁵, —CONR¹³⁶R¹³⁷, —SO₂R¹³⁸, and —SO₂NR¹³⁹R¹⁴⁰ are exemplified.

R¹³¹, R¹³², R¹³³, R¹³⁴, R¹³⁵, R¹³⁶, R¹³⁷, R¹³⁸, R¹³⁹ and R¹⁴⁰ each represents a hydrogen atom, an aliphatic group or an aromatic group.

The following couplers are preferably used as the above-described couplers.

As the yellow couplers, the couplers disclosed in U.S. Pat. Nos. 3,933,501, 4,022,620, 4,326,024, 4,401,752, 4,248,961, JP-B-58-10739 (the term “JP-B” as used herein means an“examined Japanese patent publication”), British Patents 1,425,020, 1,476,760, U.S. Pat. Nos. 3,973,968, 4,314,023, 4,511,649, EP-A-249473, the couplers represented by formulae (I) and (II) in EP-A-502424, the couplers represented by formulae (1) and (2) (in particular, Y-28 on page 18) disclosed in EP-A-513496, the coupler represented by formula (I) in claim 1 in EP-A-568037, the coupler represented by formula (I) in lines 45 to 55, column 1, in U.S. Pat. No. 5,066,576, the coupler represented by formula (I) in paragraph 0008 in JP-A-4-274425, the coupler disclosed in claim 1, page 40 (in particular, D-35on page 18) in EP-A-498381, the coupler represented by formula (Y) , page 4 (in particular, Y-1 (page 17), and Y-54 (page 41)) in EP-A-447969, and the couplers represented by formulae (II) to (IV), lines 36 to 58, column 7 (in particular, II-17 and II-19 (column 17), and II-24 (column 19)), in U.S. Pat. No. 4,476,219 are exemplified.

As the magenta couplers, the couplers disclosed in U.S. Pat. Nos. 4,310,619, 4,351,897, EP 73636, U.S. Pat. Nos. 3,061,432, 3,725,067, Research Disclosure, No. 24220 (June, 1984), ibid., No. 24230 (June, 1984), JP-A-60-33552, JP-A-60-43659, JP-A-61-72238, JP-A-60-35730, JP-A-55-118034, JP-A-60-185951, U.S. Pat. Nos. 4,500,630, 4,540,654, 4,556,630, WO 88/04795, JP-A-3-39737 (L-57, right lower column, page 11, L-68, right lower column, page 12, and L-77, right lower column, page 13), EP 456257 ((A-4)-63, page 134, (A-4)-73 and (A-4)-75, page 139), EP 486965 (M-4 and M-6, page 26, and M-7, page 27), EP-A-571959 (M-45, page 19), JP-A-5-204106 (M-1, page 6), and JP-A-4-362631 (M-22, paragraph 0237) are exemplified.

As the cyan couplers, the couplers disclosed in U.S. Pat. Nos. 4,052,212, 4,146,396, 4,228,233, 4,296,200, EP 73636, JP-A-4-204843 (CX-1, 3, 4, 5, 11, 12, 14 and 15, pages 14 to 16), JP-A-4-43345 (C-7 and C-10, page 35, C-34 and C-35, page 37, (I-1) and (I-17), pages 42 and 43, and the couplers represented by formula (Ia) or (Ib) in claim 1 in JP-A-6-67385 are exemplified.

Besides the above couplers, the couplers disclosed in JP-A-62-215272--(page 91), JP-A-2-33144 (pages 3 and 30), and EP-A-355660 (pages 4, 5, 45 and 47) are also useful in the present invention.

The compound represented by formula (I) is more preferably represented by the following formula (II):

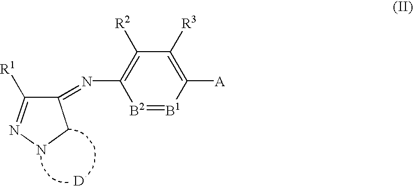

In formula (II), R¹ represents a hydrogen atom, an aliphatic group, an aromatic group, a heterocyclic group, a cyano group,

—OR¹¹, —S¹², —CO₂R¹³, —OCOR¹⁴, NR¹⁵R¹⁶, —CONR¹⁷R¹⁸, —SO₂R¹⁹, —SO₂NR²⁰R²¹, —NR²²CONR²³R²⁴, —NR²⁵CO₂R²⁶, —COR²⁷, —NR²⁸COR²⁹ or —NR³⁰SO₂R³¹. R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰ and r³¹ each represents a hydrogen atom, an aliphatic group or an aromatic group. R², R³, A, B¹ and B2 each has the same meaning as in formula (I), and the preferred ranges of them are also the same.

In formula (II), D represents an atomic group necessary to form a 5- or 6-membered nitrogen-containing heterocyclic ring, and the atomic group may be substituted with at least one substituent. The heterocyclic ring may form a condensed ring with other ring.

The examples of at least one substituent in the atomic group represented by D for forming a 5- or 6-membered nitrogen-containing heterocyclic ring include an aliphatic group, an aromatic group, a heterocyclic group, a cyano group, —OR⁸¹, —SR⁸², —CO₂R⁸³, —OCOR⁸⁴, —NR⁸⁵R⁸⁶, —CON⁸⁷R⁸⁸, —SO₂R⁸⁹, —SO₂NR⁹⁰R⁹¹, —NR⁹²CONR⁹³R⁹⁴, —NR⁹⁵CO₂R⁹⁶, —COR⁹⁷, —NR⁹⁸COR⁹⁹ and —NR¹⁰⁰SO₂R¹⁰¹.

R⁸¹, R⁸², R⁸³, R⁸⁴, R⁸⁵, R⁸⁶, R⁸⁷, R⁸⁸, R⁸⁹, R⁹⁰, R⁹¹, R⁹², R⁹³, R⁹⁴, R⁹⁵, R⁹⁶,R⁹⁷, R⁹⁸, R⁹⁹, R¹⁰⁰ and R¹⁰¹ each represents a hydrogen atom, an aliphatic group or an aromatic group.

In formula (II), R¹ preferably represents a hydrogen atom, an aliphatic group, an aromatic group, —OR¹¹, —SR¹², —NR¹⁵,R¹⁶, —SO₂R¹⁹, —NR²²CONR²³R²⁴, —NR²⁵CO₂R²⁶, —OR¹¹, —SR¹², —NR¹⁵R¹⁶, —SO₂R¹⁹, —NR²²CONR²³R^{24 , —NR}²⁵CO₂R²⁶, —NR²⁸COR²⁹ or —NR³⁰SO₂R³¹, more preferably a hydrogen atom, an aliphatic group, an aromatic group, —OR¹¹ or —NR¹⁵R¹⁶, still more preferably a hydrogen atom, an alkyl group, a substituted alkyl group, an aryl group, a substituted aryl group, an alkoxyl group, a substituted alkoxyl group, a phenoxy group, a substituted phenoxy group, a dialkylamino group, or a substituted dialkylamino group, particularly preferably a hydrogen atom, an alkyl group having from 1 to 10 carbon atoms, a substituted alkyl group having from 1 to 10 carbon atoms, an aryl group having from 6 to 10 carbon atoms, or a substituted aryl group having from 6 to 10 carbon atoms, and most preferably a hydrogen atom, an alkyl group having from 1 to 6 carbon atoms, or a substituted alkyl group having from 1 to 6 carbon atoms.

In formula (II), A preferably represents —NR⁴R⁵. It is preferred that D form a 5-membered nitrogen-containing heterocyclic ring, and the more preferred examples of the 5-membered nitrogen-containing heterocyclic rings include, e.g., an imidazole ring, a triazole ring, and a tetrazole ring.

Of the compounds represented by formula (II), an oil-soluble pyrazolotriazole azomethine compound represented by the following formula (III) is particularly preferred:

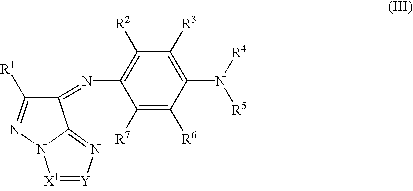

In formula (III), R¹, R², R³, R⁴, R⁵R⁶ and R⁷ each has the same meaning as in formula (II). X¹ and Y each represents —C(R⁸)═or —N═. R⁸ represents a hydrogen atom, an aliphatic group or an aromatic group. Either X¹ or Y necessarily represents —N═, and both: X¹ and Y do not represent —N═at the same time.

In formula (III), R⁸ preferably represents a hydrogen atom, an alkyl group, a substituted alkyl group, an aryl group or a substituted aryl group, more preferably a hydrogen atom, a substituted alkyl group having from 1 to 150 carbon atoms, or a substituted aryl group having from 6 to 150 carbon atoms, and particularly preferably a substituted alkyl group having from 1 to 100 carbon atoms, or a substituted aryl group having from 6 to 100 carbon atoms.

When both of X¹ and Y represent —(R⁸)═, each R⁸ may be bonded to form a ring, and the ring is preferably a 6-membered ring, and more preferably an aromatic ring (e.g., a benzene ring, etc.).

Of the compounds represented by formula (III), a pyrazolotriazole azomethine compound in which X¹ represents —N═and Y represents —C(R 8)═is preferred.

Exemplified Compounds (M-1) to (M-16) of a pyrazolotriazole azomethine compound represented by formula (III) are shown below, but the present invention is not limited to these compounds.

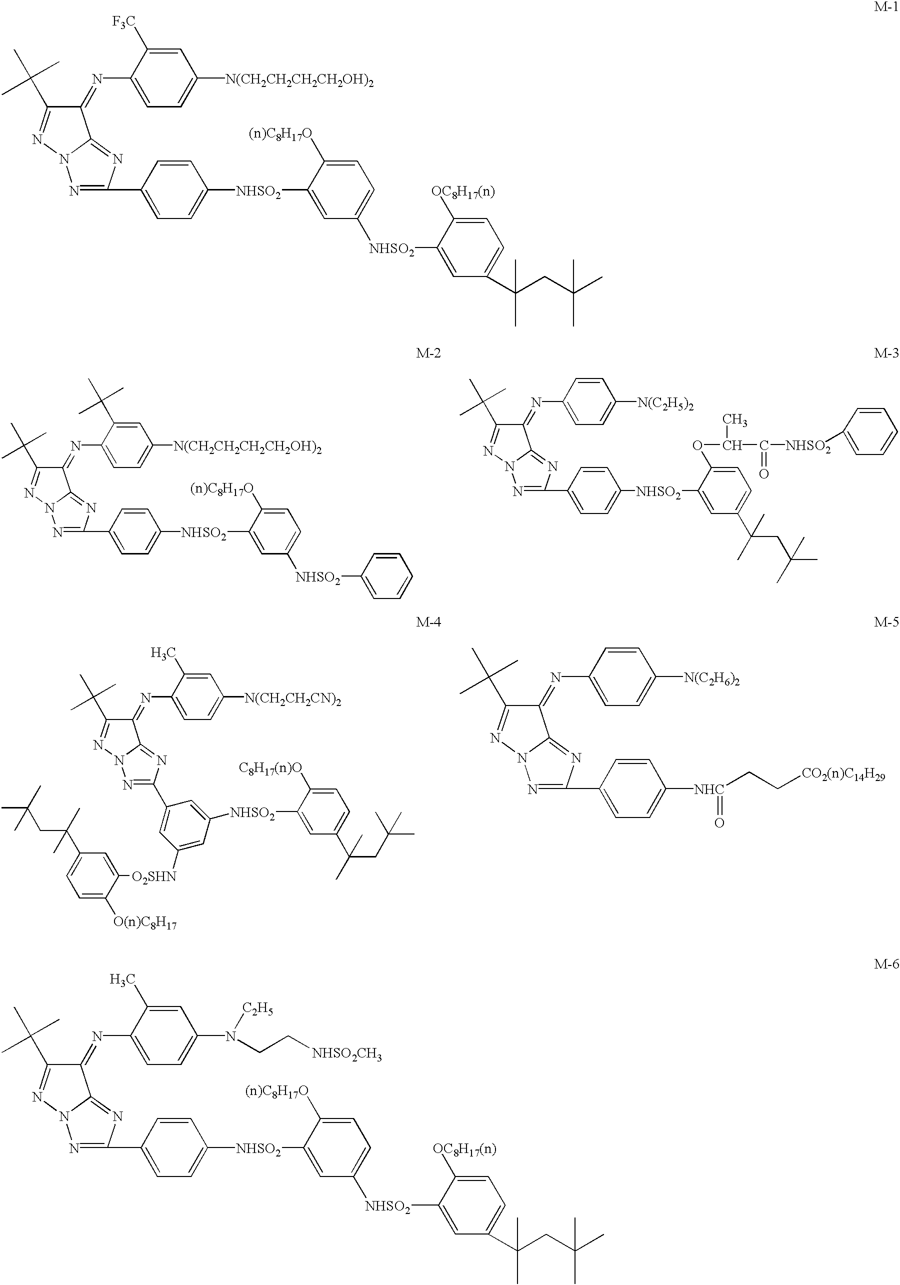

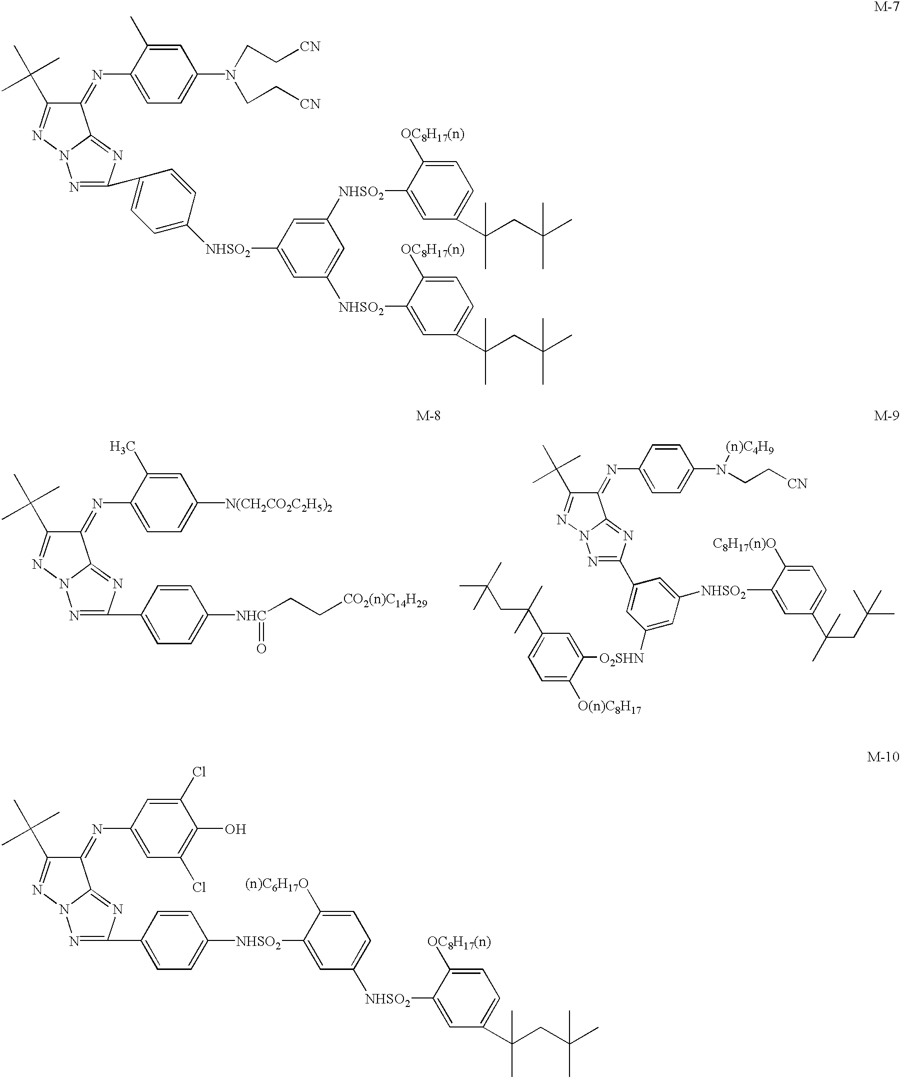

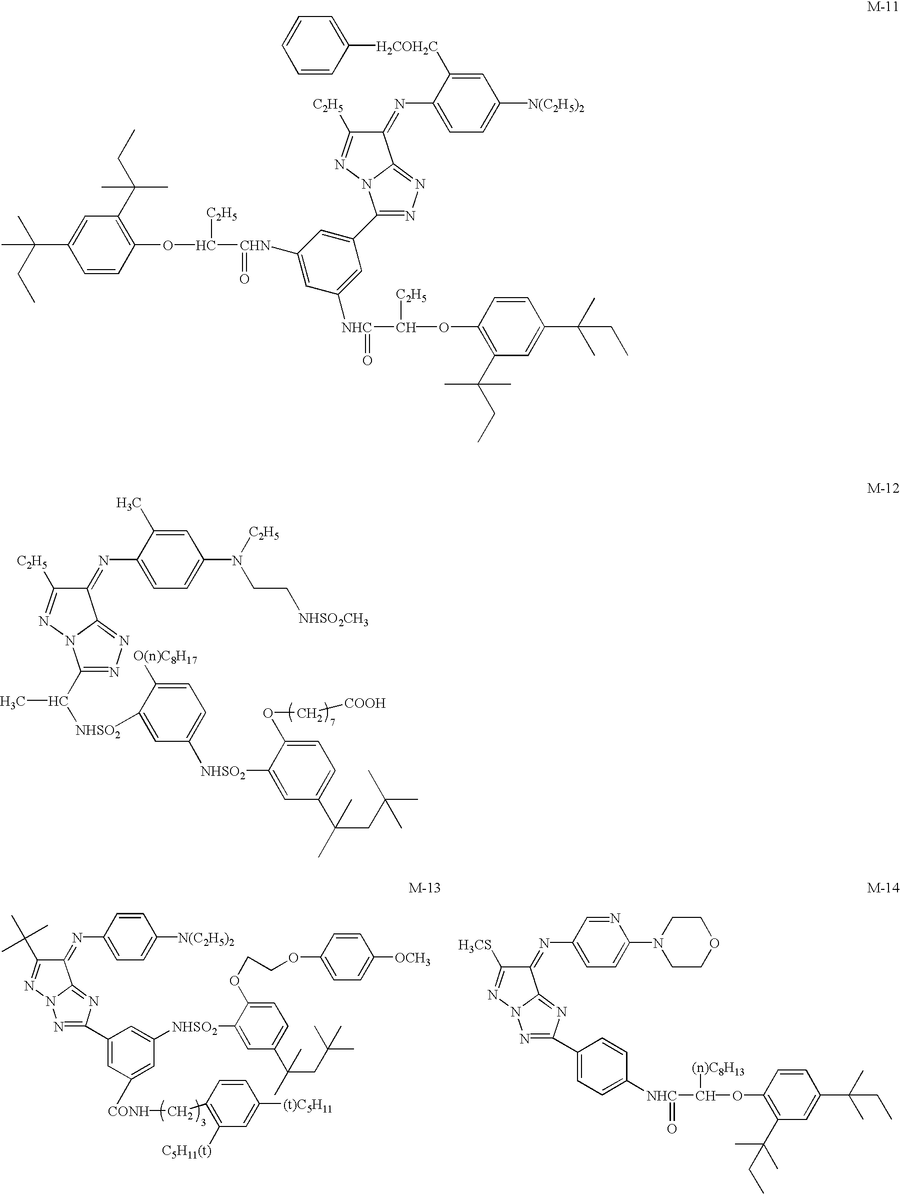

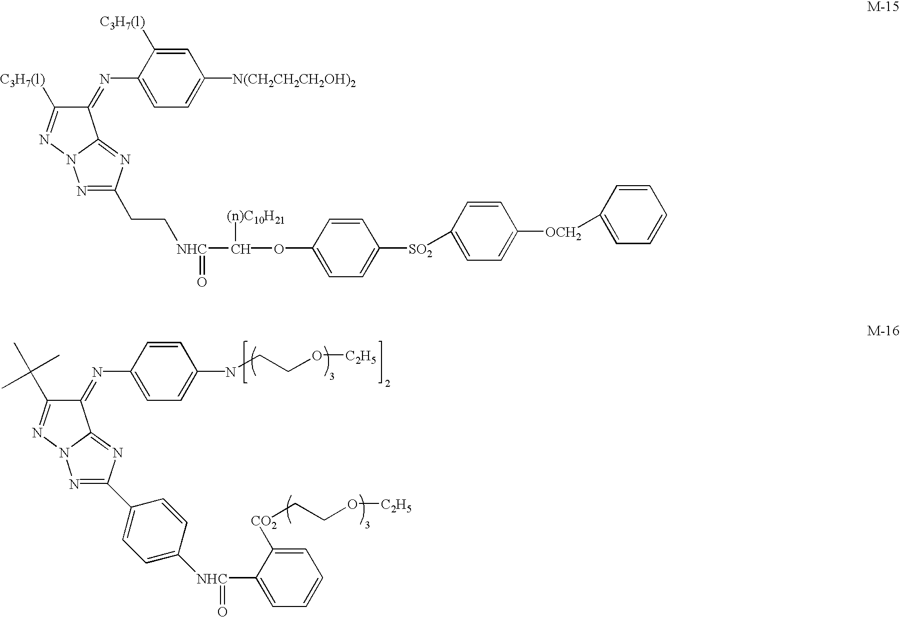

Further, exemplified compounds disclosed in Japanese Patent Application No.2000-78491 can also be used in the present invention, but the present invention is not limited thereto.

The compound represented by formula (II) can be synthesized by referring to the methods disclosed, e.g., in JP-A-4-126772, JP-B-7-94180 and Japanese Patent Application No. 2000-78491.

As cyan dyes, the pyrrolotriazole azomethine compounds represented by the following formulae (IV-1) to (IV-4) are particularly preferably used.

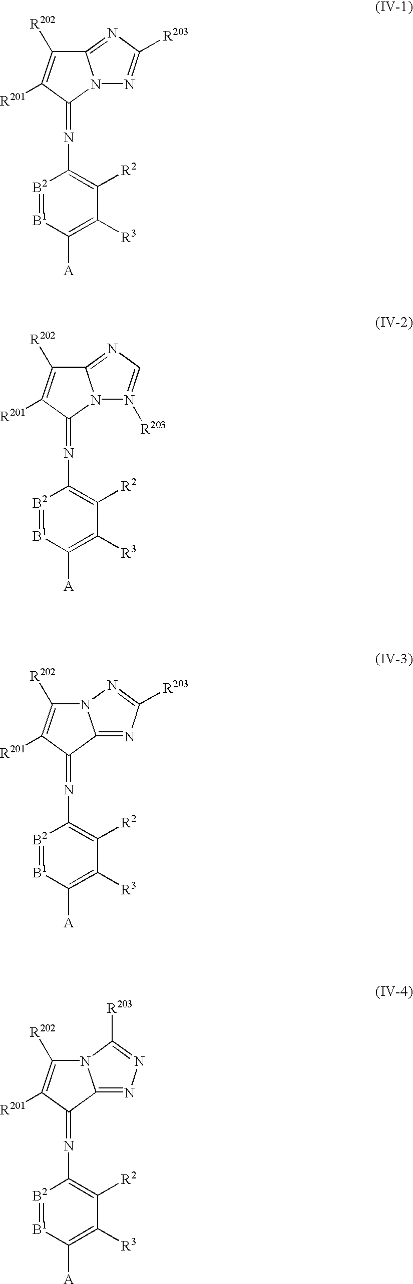

In formulae (IV-1) to (IV-4), A, R², R³, B¹ and B² each has the same meaning as in formula (I), and their preferred ranges are also the same. R 201, R202 and R203 each has the same meaning as R¹ in formula (II). R201 and R²⁰² may be bonded to each other to form a ring.

The pyrrolotriazole azomethine compounds represented by formulae (IV-1) to (IV-4) have sharp absorption when R²⁰¹ is an electron attractive group having a Hammett's substitution constant oₚ value of 0.30 or more.

The pyrrolotriazole azomethine compounds represented by formulae (IV-1) to (IV-4) in which the sum of the Hammett's substitution constant σₚvalues of R²⁰¹ and R²⁰² is 0.70 or more are particularly preferred because their cyan color shows an excellent hue.

The hues of the pyrrolotriazole azomethine compounds represented by formulae (IV-1) to (IV-4) are described below.

The pyrrolotriazole azomethine compounds represented by formulae (IV-1) to (IV-4) can have various hues by combinations of R²⁰¹, R²⁰², R²⁰³, and R², R³, A, B¹, B².

The absorption wave form of the pyrrolotriazole azomethine compounds represented by formulae (IV-1) to (IV-4) becomes sharper when R201 is an electron attractive substituent as compared with the case where R²⁰¹ is not an electron attractive substituent. The stronger the degree of the electron attraction, the sharper is the absorption wave form. From this point, R²⁰¹ preferably represents an electron attractive group having a Hammett's substitution constant σₚ value of 0.30 or more rather than an alkyl group or an aryl group, more preferably an electron attractive group having a Hammett's substitution constant σₚ value of 0.45 or more, and particularly preferably an electron attractive group having the value of 0.60 or more.

The pyrrolotriazole azomethine compounds can be used as magenta dyes and cyan dyes, but it is more preferred to use them as cyan dyes. The pyrrolotriazole azomethine compounds represented by formulae (IV-1) to (IV-4) can also be used as magenta dyes.

For using the pyrrolotriazole azomethine compounds represented by formulae (IV-1) to (IV-4) as cyan compounds, it is preferred that the sum of the Hammett's substitution constant σₚ values of R²⁰¹ and R²⁰² be 0.70 or more. When the sum of the σₚ values is less than 0.70, the maximum absorption wavelength is short as a cyan dye, and the dye appears to be blue to human eyes, which is not preferred. The Hammett's substitution constant σₚ value of R²⁰² is preferably 0.30 or higher, and the sum of the Hammett's substitution constant σₚ values of R201 and R202 is preferably 2.0 or less.

The examples of electron attractive groups having a Hammett's substitution constant σₚ value of 0.30 or higher include, e.g., an acyl group, an acyloxy group, a carbamoyl group, an alkoxycarbonyl group, an aryloxycarbonyl group, a cyano group, a nitro group, an alkylsulfinyl group, an arylsulfinyl group, an alkylsulfonyl group, an arylsulfonyl group, a sulfamoyl group, an alkyl halide group, an alkoxy halide group, an aryloxy halide group, an alkylthio halide group, and an aryl group and a heterocyclic group substituted with two or more electron attractive groups having op values of 0.15 or more.

More specifically, an acyl group (e.g., acetyl, 3-phenylpropanoyl, etc.), an acyloxy group (e.g., acetoxy, etc.), a carbamoyl group (e.g., N-ethylcarbamoyl, N,N-dibutylcarbamoyl, N-(2-dodecyloxyethyl) carbamoyl, N-methyl-N-dodecylcarbamoyl, etc.), an alkoxycarbonyl group (e.g., methoxycarbonyl, butyloxycarbonyl, dodecyloxycarbonyl, octadecyloxycarbonyl, etc.), an aryloxycarbonyl group (e.g., phenoxycarbonyl, etc.), a cyano group, a nitro group, an alkylsulfinyl group (e.g., 3-phenoxypropylsulfinyl, etc.), an arylsulfinyl group (e. g., 3-pentadecylphenylsulfinyl, etc.), an alkylsulfonyl group (e.g., methanesulfonyl, octanesulfonyl, etc.), an arylsulfonyl group (e.g., benzenesulfonyl, etc.), a sulfamoyl group (e.g., N-ethylsulfamoyl, N,N-dipropylsulfamoyl, etc.), an alkyl halide group (e.g., trifluoromethyl, heptafluoropropyl, etc.), an alkoxy halide group (e.g., trifluoromethyloxy, etc.), an aryloxyhalide group (e.g., pentafluorophenyloxy, etc.), an alkylthio halide group (e.g., difluoromethylthio, etc.), an aryl group substituted with two or more electron attractive groups having σₚ values of 0.15or more (e.g., 2,4-dinotrophenyl, 2,4,6-trichlorophenyl, pentachlorophenyl, etc.), and a heterocyclic group substituted with two or more electron attractive groups having σₚvalues of 0.15 or more (e.g., 2-benzoxazolyl, 2-benzothiazolyl, 1-phenyl-2-benzimidazolyl, 5-chloro-1-tetrazolyl, 1-pyrrolyl, etc.) are exemplified.

The examples of electron attractive groups having a Hammett's substitution constant σₚvalue of 0.45 or more include, e.g., an acyl group (e.g., acetyl, 3-phenylpropanoyl, etc.), an alkoxycarbonyl group (e.g., methoxycarbonyl, etc.), an aryloxycarbonyl group (e.g., m-chlorophenoxycarbonyl, etc.), a cyano group, a nitro group, an alkylsulfinyl group (e.g., n-propylsulfinyl, etc.), an arylsulfinyl group (e.g., phenylsulfinyl, etc.), an alkylsulfonyl group (e.g., methanesulfonyl, n-octanesulfonyl, etc.), an arylsulfonyl group (e.g., benzenesulfonyl, etc.) , a sulfamoyl group (e.g., N-ethylsulfamoyl, N,N-dipropylsulfamoyl, etc.), and an alkyl halide group (e.g., trifluoromethyl, etc.).

As electron attractive groups having a Hammett's substitution constant σₚvalue of 0.60 or more, a cyano group (0.66), a nitro group (0.78), and a methanesulfonyl group (0.72) are exemplified.

As the combinations having the sum of the Hammett's substitution constant σₚ values of R²⁰¹ and R²⁰² is 0.70 or more, the combinations with R²⁰¹ being selected from a cyano group, an alkoxycarbonyl group, an alkylsulfonyl group, an arylsulfonyl group and an alkyl halide group, and R²⁰² being selected from an acyl group, an acyloxy group, a carbamoyl group, an alkoxycarbonyl group, an aryloxycarbonyl group, a cyano group, an alkylsulfonyl group, an arylsulfonyl group, a sulfamoyl group and an alkyl halide group are preferred.

A pyrrolotriazole azomethine compound having a preferred structure in the present invention is a compound represented by the following formula (IV-1a), wherein R² represents a hydrogen atom, an alkyl group having from 1 to 4 carbon atoms, a substituted alkyl group having from 1 to 4 carbon atoms, a halogen atom (fluorine, chlorine, bromine), an acylamino group having from 1 to 5 carbon atoms, an aminocarbonylamino group having from 1 to 5 carbon atoms, or an alkoxycarbonylamino group having from 2 to 5 carbon atoms; R⁴ and R⁵ each represents a hydrogen atom, an alkyl group having from 1 to 18 carbon atoms, a substituted alkyl group having from 1 to 18 carbon atoms; R²⁰¹ and R²⁰² each represents an electron attractive group wherein the sum of the Hammett's substitution constant σₚ values is 0.30 or more; R203 represents an alkyl group having from 1 to 18 carbon atoms, a substituted alkyl group having from 1 to 18 carbon atoms, or a substituted or unsubstituted aryl group having from 6 to 20 carbon atoms.

When the pyrrolotriazole azomethine compound is used as a cyan dye, the compounds wherein the sum of the Hammett's substitution constant op values of R²⁰¹ and R²⁰² is 0.70 or more are preferably used, more preferably the sum of the Hammett's substitution constant σₚ values is 1.00 or more.

Of the pyrrolotriazole azomethine compounds for use in the present invention, the compounds wherein R² represents a hydrogen atom or a methyl group, R⁴ and R⁵ each represents an alkyl group having from 1 to 5 carbon atoms, R²⁰¹ represents a cyano group, R202 represents an alkoxycarbonyl group, and R203 represents an aryl group are most preferred.

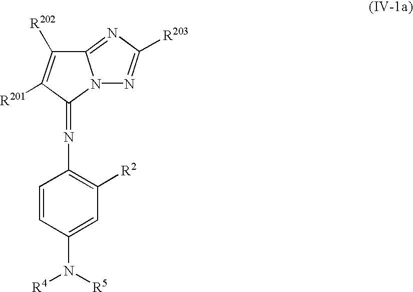

The Hammett's substitution constant for use in the present invention is described in the specification of JP-A-2001-181547 and the σₚ value in the present invention has the same meaning as defined in the above patent.

Exemplified compounds (C-1) to (C-9) of pyrrolotriazole azomethine compounds in the present invention are shown below, but the present invention is not limited to these compounds.

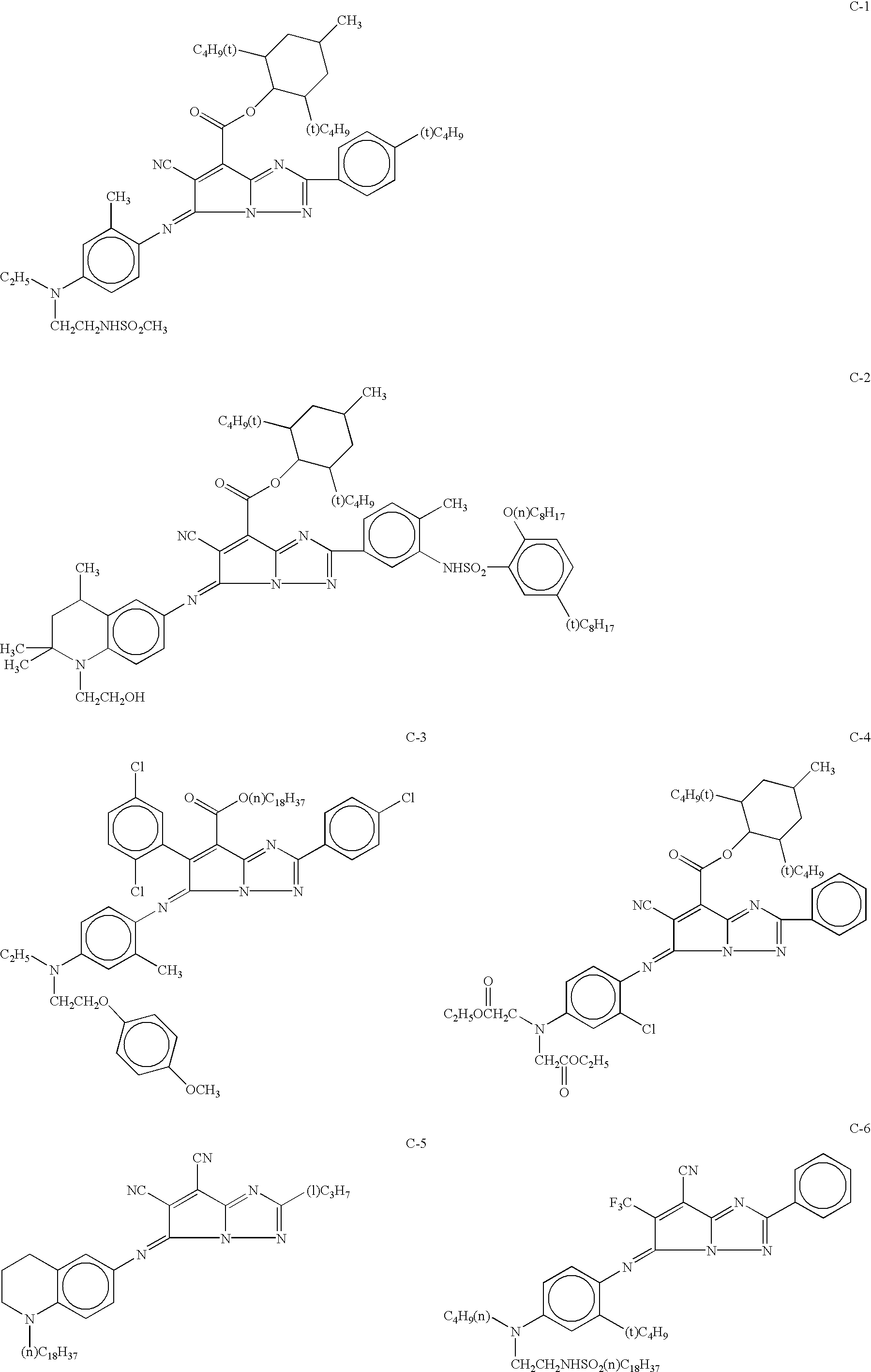

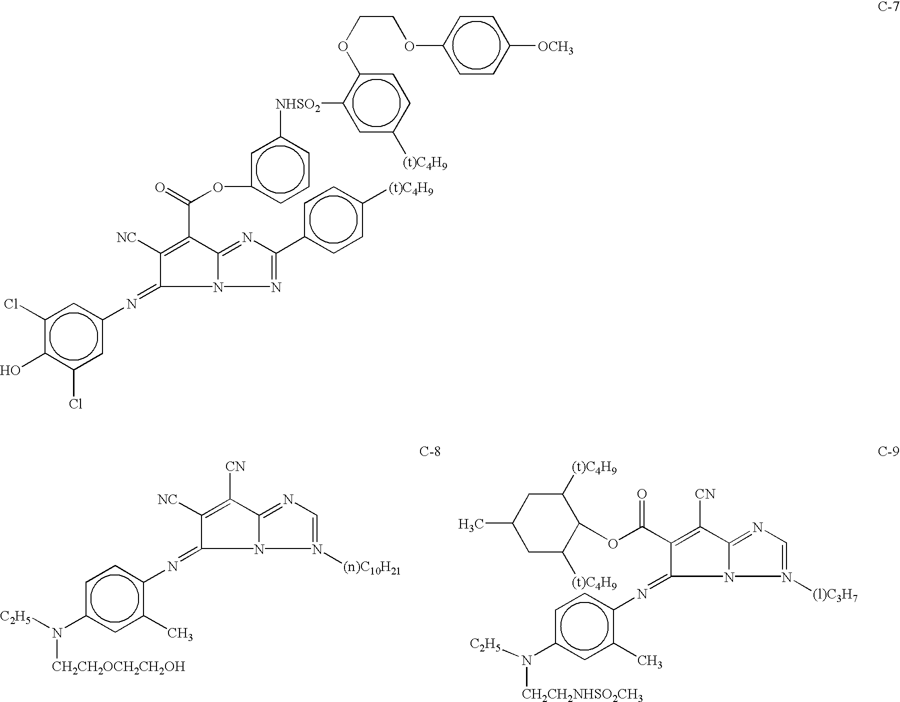

Further, exemplified compounds disclosed in JP-A-2001-181547 can also be used in the present invention, but the present invention is not limited thereto.

The pyrrolotriazole azomethine compounds represented by formulae (IV-1) to (IV-4) can be synthesized by referring to the methods disclosed, e.g., in JP-A-5-177959, JP-A-9-292679, JP-A-10-62926 and JP-A-181547.

Hydrophobic Ethylenically Unsaturated Monomer:

The above-described hydrophobic ethylenically unsaturated monomer (hereinafter sometimes referred to as “the monomer of the present invention”) is a compound having a polymerizable ethylenically double bond which is solidified by the application of energy, e.g., ultraviolet rays,. heat or electron beams. “Hydrophobic” means having a solubility of 10% or less in water, preferably a solubility of 3% or less. Monomers for use in the present invention may be so-called monofunctional compounds having one ethylenically unsaturated group (hereinafter referred to as “monofunctional monomers”), may be bifunctional or higher functional compounds (hereinafter referred to as “polyfunctional monomers”), or one or more monofunctional monomers and polyfunctional monomers may be used as mixture. The kinds of monomers can be arbitrarily selected with the objects of the control of the viscosity of coloring fine particles and the physical control of the polymer after polymerization of the monomer (compatibility with an oil-soluble dye, strength, and the adhesion with the base material).

As polymerizable groups, an acryloyl group, a methacryloyl group, an allyl group, a vinyl group, and an internal double bonding group (e.g., maleic acid, etc.) are exemplified. Of these groups, an acryloyl group and a methacryloyl group are excellent in polymerizability and preferred as they can be hardened with a small amount of initiating seed and low energy, and an acryloyl group is particularly preferred.

As polyfunctional monomers, vinyl group-containing aromatic compounds, acrylate (or methacrylate) which is ester of divalent or higher alcohol with acrylic acid (or methacrylic acid), acrylamide (or methacrylamide) which is amide of divalent or higher amine with acrylic acid or methacrylic acid, polyester acrylate obtained by introducing acrylic acid or methacrylic acid into ester obtained by bonding polybasic acid and divalent alcohol, or polycaprolactone, polyether acrylate obtained by introducing acrylic acid or methacrylic acid into ether obtained by bonding alkylene oxide and polyhydric alcohol, epoxy acrylate obtained by introducing acrylic acid or methacrylic acid into epoxy resin, or by the reaction of divalent or higher alcohol and epoxy-containing monomer, urethane acrylate having a urethane bond, amino resin acrylate, acrylic resin acrylate, alkyd resin acrylate, spiran resin acrylate, silicone resin acrylate, reaction products of unsaturated polyester and the above photopolymerizable monomers, and reaction products of waxes and the above polymerizable monomers are exemplified. Of these polyfunctional monomers, acrylate, polyester acrylate, polyether acrylate, epoxy acrylate, urethane acrylate, acrylic resin acrylate, silicone resin acrylate, and reaction products of unsaturated polyester and the above photopolymerizable monomers are preferred, and acrylate, polyester acrylate, polyether acrylate, epoxy acrylate, and urethane acrylate are especially preferred.

The examples of polyfunctional monomers include divinylbenzene, trivinyl cyclohexane, ethylene glycol dimethacrylate, 1,3-butanediol diacrylate, 1,6-hexanediol diacrylate, pentaerythritol triacrylate, trimethylolpropane triacrylate, dipentaerythritol hexaacrylate, 1,6-acryloyl-aminohexane, hydroxypivalate neopentyl glycol diacrylate, polyester acrylate having a (meth) acryloyl group on the terminal of the molecular chain of polyester comprising a dibasic acid and a divalent alcohol having a molecular weight of from 500 to 30, 000, polyethylene glycol diacrylate, epoxy acrylate having a molecular weight of from 450 to 30,000 containing bisphenol (A, S or F) skeleton (i.e., basic structure), epoxy acrylate having a molecular weight of from 600 to 30,000 containing a phenol novolak resin skeleton, a reaction product of polyvalent isocyanate having a molecular weight of from 350 to 30,000 and a (meth) acrylic acid monomer having a hydroxyl group, and a urethane modified product having a urethane bond in the molecule.

As monofunctional monomers, substituted or unsubstituted (meth)acrylate, substituted or unsubstituted styrenes, substituted or unsubstituted acrylamide, vinyl group-containing monomers (e.g., vinyl esters, vinyl ethers, N-vinylamide, etc.) and a (meth)acrylic acid are exemplified, substituted or unsubstituted (meth)acrylate, substituted or unsubstituted acrylamide, vinyl esters and vinyl ethers are preferred, and substituted or unsubstituted (meth)acrylate and substituted or unsubstituted acrylamide are particularly preferred.

The examples of monofunctional monomers include n-butyl acrylate, t-butyl acrylate, t-octyl acrylate, n-hexyl acrylate, 2-ethylhexyl acrylate, n-dodecyl acrylate, benzyl acrylate, 1H,1H,2H,2H-perfluorohexyl acrylate, n-butyl methacrylate, sec-butyl methacrylate, n-hexyl methacrylate, 2-ethylhexyl methacrylate, n-dodecyl methacrylate, octadecyl methacrylate, benzyl methacrylate, hydroxybutyl acrylate, 2-chloroethyl acrylate, glycidyl acrylate, allyl acrylate, diphenyl-2-methacryloyloxyethyl phosphate, N-butoxymethyl-acrylamide, t-butylacrylamide, t-octylacrylamide, phenyl-acrylamide, 2-hydroxybutyl vinyl ether, styrene, methylstyrene, p-chlorostyrene, p-t-butylstyrene, methoxystyrene, vinyl acetate, vinyl caproate, vinyl benzoate and poly-dimethylsiloxane monoacrylate.

Polymerization Initiator:

As polymerization initiators, azobis compounds, peroxides, hydroperoxides and redox catalysts can be used, and specifically, such as inorganic peroxides, e.g., potassium peroxide and ammonium peroxide, organic peroxides, e.g., t-butyl peroctoate, benzoyl peroxide, isopropyl percarbonate, 2,4-dichlorobenzoyl peroxide, methyl ethyl ketone peroxide, cumene hydroperoxide, and dicumyl peroxide, 2,2′-azobisisobutyrate, 2,2′-azobisisobutyronitrile, 2,2′-azobis(2,4-dimethylvaleronitrile), 1,1′-azobis(cyclohexane-l-carbonitrile), 2,2′-azobis(2,4,4-trimethylpentane), 2,2′-azobiscyanovalerate, 1,1′-azobis(l-acetoxy-l-phenylethane), 2,2′-azobis(2-amidinopropane)hydrochloride, 2,2′-azobis[2-(5-methyl-2-imidazolin-2-yl)propane]hydrochlo ride, and2,2′-azobis{2-methyl-N-[1, ′-bis(hydroxymethyl)-2-hydroxyethyl]propionamide} are exemplified.

It is preferred that these polymerization initiators are contained in coloring fine particles, i.e., these polymerization initiators are soluble in oil, and it is particularly preferred that they are azobis compounds. Accordingly, as the examples of particularly preferred thermal polymerization initiators, 2,2′-azobisisobutyrate, 2,2′-azobisisobutyronitrile, 2,2′-azobis(2,4-dimethylvaleronitrile), 1,1′-azobis(cyclohexane-1-carbonitrile), and 2,2′-azobis(2,4,4-trimethylpentane) are exemplified.

When radiation is used in the present invention for proceeding polymerization of a monomer, α-rays, γ-rays, X-rays, ultraviolet rays, visible rays and electron beams can be used as the radiation. Of these radiations, ultraviolet rays and visible rays are preferably used from the point of cost and safety, and ultraviolet rays are more preferably used. When ultraviolet rays and visible rays are used as the radiation, photopolymerization initiators are used in combination for initiating polymerization.

Photopolymerization initiators are not-particularly restricted. so long as the radicals generated by light and other active seeds react with the polymerizable double bonds in the monomers.

As photopolymerization initiators, acetophenone derivatives, benzophenone derivatives, benzyl derivatives, benzoin derivatives, benzoin ether derivatives, benzylalkyl ketal derivatives, thioxanthone derivatives, acylphosphine oxide derivatives, metal complexes, p-dialkylaminobenzoic acid, azo compounds and peroxide compounds are generally known, and acetophenone derivatives, benzyl derivatives, benzoin ether derivatives, benzylalkyl ketal derivatives, thioxanthone derivatives and acylphosphine oxide derivatives are preferred, and acetophenone derivatives, benzoin ether derivatives, benzylalkyl ketal derivatives and acylphosphine oxide derivatives are particularly preferred.

The examples of photopolymerization initiators include acetophenone, 2,2-diethoxyacetophenone, p-dimethyl-aminoacetophenone, p-dimethylaminopropiophenone, benzo-phenone, p,p′-dichlorobenzophenone, p,p′-bisdiethylamino-benzophenone, Michler's ketone, benzyl, benzoin, benzoin methyl ether, benzoin isopropyl ether, benzoin-n-propyl ether, benzoin isobutyl ether, benzyl methyl ketal, 1-hydroxycyclohexyl phenyl ketone, tetramethylthiuram monosulfide, thioxanthone, 2-chlorothioxanthone, 2,4-dimethylthioxanthone, 2,2-dimethylpropioyl: diphenylphosphine oxide, 2-methyl-2-ethylhexanoyl diphenylphosphine oxide, 2,6-dimethylbenzoyl diphenylphosphine oxide, 2,6-dimethoxybenzoyl diphenylphosphine oxide, 2,4,6-trimethylbenzoyl diphenylphosphine oxide, bis(2,6-dimethoxybenzoyl)-2,4,4-trimethylpentyl phosphine oxide, 2,3,6-trimethylbenzoyl diphenylphosphine oxide, bis(2,3,6-trimethylbenzoyl)phenylphosphine oxide, 2,4,6-trimethoxybenzoyl diphenylphosphine oxide, 2,4,6-trichlorobenzoyl diphenylphosphine oxide, 2,4,6-trimethylbenzoyl naphthylphosphonate, bis (η⁵-2,4-cyclopentadien-1-yl)-bis[2,6-difluoro-3-(1H-pyrrol-1-yl) finyl] titanium, p-dimethylaminobenzoic acid, p-diethylaminobenzoic acid, azobisisobutyronitrile, 1,1′-azobis(1-acetoxy-1-phenylethane), benzoin peroxide and di-tert-butyl peroxide.

As further examples of photopolymerization initiators, the photopolymerization initiators described in Kiyoshi Kato, Sekigaisen Koka System (Hardening System by Ultraviolet Rays), pp. 65 to 148, published by Sogo Gijutsu Center Co. (1989) can be exemplified.

Photopolymerization initiators can be used alone or in combination of two or more, and may be used in combination with a sensitizer.

The amount of these photopolymerization initiators is not particularly restricted, but the amount is preferably from 0.5 to 20-mass % (i.e., weight %)) based on the hydrophobic ethylenically unsaturated monomer, more preferably from 1 to 15 mass %, and particularly preferably from 3 to 10 mass %. If the amount of photopolymerization initiators is less than 0.5 mass %, resins are not hardened or the hardening time is prolonged, and if the amount is more than 20 mass %, precipitation or separation of the coloring fine particle dispersion occurs with the lapse of time, which sometimes leads to the deteriorations of the characteristics, e.g., the strength of the ink after hardening and scratch resistance, and so not preferred.

The sensitizer is not activated by irradiation with light by itself, and is a compound which is effective when used with a photopolymerization initiator as compared with the case where a photopolymerization initiator is used alone, and generally amines are used as the sensitizer. The reasons hardening speed is accelerated by the addition of amines are that hydrogen is supplied to a photopolymerization initiator by hydrogen-pulling function of amines, and that amines have a function of capturing the oxygen in a composition in contrast to the fact that the generated radicals are bonded to the oxygen molecules in air to thereby worsen reactivity.

As the sensitizers, amine compounds (e.g., aliphatic amine, amines containing an aromatic group, piperidine, reaction products of epoxy resin and amine, and triethanolamine triacrylate), urea compounds (e.g., allylthiourea and o-tolylthiourea), sulfur compounds (e.g., sodium diethyl-dithiophosphate, and soluble salts of aromatic sulfinic acid), nitrile series compounds (e.g., N,N-diethyl-p-amino-benzonitrile), phosphorus compounds (e.g., tri-n-butyl-phosphine and sodium diethyldithiophosphite), nitrogen compounds (e.g., Michler's ketone, N-nitrosohydroxylamine derivatives, oxazolidine compounds, tetrahydro-1,3-oxazine compounds, and condensation products of formaldehyde or acetaldehyde with diamine), and chlorine compounds (e.g., carbon tetrachloride and hexachloroethane) are exemplified.

The use amount of sensitizers is generally from 0.1 to 10 mass %, preferably from 0.2 to 5 mass %, and particularly preferably from 0.2 to 2 mass %. With respect to the selection, combination and mixing ratio of photopolymerization initiators and sensitizers, they can be arbitrarily selected according to the hydrophobic ethylenically unsaturated monomers used and apparatus used.

As the light sources of ultraviolet and visible ray irradiation, a low pressure mercury lamp, a high pressure mercury lamp, a metal halide lamp, a carbon arc lamp, a xenon lamp, and a chemical lamp can be used.

In addition to the above hydrophobic ethylenically unsaturated monomers, oil-soluble dyes and polymerization initiators, the coloring fine particles of the present invention can arbitrarily contain, high boiling point hydrophobic organic solvents and polymers for the purpose of controlling the viscosity and polarity of the coloring fine particles themselves and controlling polymerization activity.

The high boiling point organic solvents are organic solvents having a boiling point of 100° C. or more, preferably 150° C. or more, and more preferably 170° C. or more, e.g., polyhydric alcohols, aliphatic carboxylic esters, phosphoric esters, and hydrocarbon can be exemplified. Specifically, the examples of the high boiling point organic solvents include diethylene glycol, trimethylolpropane, dibutyl phthalate, 2-ethylhexylbenzoate, and alkylnaphthalene. More specifically, the hydrophobic high boiling point organic solvents disclosed in JP-A-2001-20463 can be exemplified. These organic solvents may be liquid or solid at room temperature. They may be used alone or in combination of two or more, and the use amount is preferably from 0 to20mass %, and more preferably from 0 to 10 mass %.

The above polymers can be used for controlling the polarity and viscosity of coloring fine particles, improving the solubility of oil-soluble dyes, improving the adhesion of the material to be printed and ink, and controlling light fastness. The polymers preferably have high compatibility with dyes and monomers, and the molecular weight of the polymers is preferably 50,000 or less, and more preferably 20,000 or less. As the polymers, e.g., vinyl polymer, polyurethane and polyester are exemplified, specifically polybutyl acrylate, poly(isobutyl methacrylate/hydroxyethyl acrylate) (copolymerization mass ratio (i.e., weight ratio): 95/5), poly(isopropyl acrylate/tetrahydrofurfuryl acrylate) (copolymerization mass ratio: 70/30), poly(butyl methacrylate/N-methoxymethyl acrylamide) (copolymerization mass ratio: 80/20), polybutyl acrylate/polydimethylsiloxane block copolymers (copolymerization mass ratio: 90/10) can be exemplified.

These polymers may be used alone or in combination of two or more. The use amount of the polymers varies according to the kinds and the amounts of ethylenically unsaturated monomers and oil-soluble dyes, but is preferably from 0 to 40 mass %, and particularly preferably from 0 to 20 mass %.

In the present invention, a storage stabilizer can be contained in the coloring fine particles or in the aqueous phase of water color inks. The storage stabilizer is a compound to inhibit undesired polymerization of monomers during storage. The examples of the storage stabilizers include quaternary ammonium salt, hydroxylamines, cyclic amides, nitriles, substituted ureas, heterocyclic compounds, organic acids, hydroquinone., hydroquinone monoethers, organic phosphines and copper compounds. Specifically, benzyltrimethylammonium chloride, diethylhydroxylamine, benzothiazole, 4-amino-2,2,6,6-tetramethylpiperidine, citric acid, hydroquinone monobutyl ether, and copper naphthenate can be exemplified. The use amount is preferably from 0.005 to 1 mass % (i.e., weight %) based on the polymerizable ethylenically unsaturated monomer, more preferably from 0.01 to 0.5 mass %, and particularly preferably from 0.01 to 0.2 mass %.

Manufacture of Coloring Fine Particle Dispersion:

The coloring fine particle dispersion in the present invention contains at least an oil-soluble dye and the monomer of the present invention, preferably comprises coloring fine particles containing a polymerization initiator dispersed in an aqueous medium. Specifically, a method of co-emulsification dispersing an oil-soluble dye and the monomer of the present invention is exemplified (a co-emulsifying dispersion method). As the co-emulsifying dispersion method, a method of emulsifying and making fine particles an oil-soluble dye and the monomer of the present invention by either adding water to an organic solvent phase containing the oil-soluble dye and the monomer of the present invention or adding the organic solvent phase to water is exemplified as a preferred method.

As an emulsifying dispersion apparatus for use in the co-emulsifying dispersion method, well-known apparatus, e.g., apparatus of stirring system such as a simple stirrer and an impeller, an in-line stirring system, a mill system such as a colloid mill, and an ultrasonic wave system can be used, but high pressure emulsification dispersing apparatus is preferably used in the present invention, and a high pressure homogenizer is particularly preferred.

High pressure homogenizers are disclosed in U.S. Pat. No. 4,533,254 and JP-A-6-47264 in detail with respect to the mechanism. As commercially available products, Gaulin homogenizer (manufactured by A.P.V. Gaulin Inc.), Micro-fluidizer (manufactured by Microfluidex Inc.), and Ultimizer (manufactured by Sugino Machine Co., Ltd.) are exemplified.

A pressure homogenizer equipped with the mechanism of making fine particles in ultra-high pressure jet stream as has been disclosed in U.S. Pat. No. 5,720,551 in recent years is particularly effective for emulsifying dispersion in the present invention.

As an example of emulsification dispersing apparatus using the ultra-high pressure jet stream, DeBEE2000 (Bee International Ltd.) can be exemplified.

The pressure at the time of emulsification dispersing by the above high pressure emulsification dispersing apparatus is preferably 50 MPa or more (500 bar or more), more preferably 60 MPa or more (600 bar or more), and still more preferably 180 MPa or more (1,800 bar or more).

In the present invention, at the time of emulsifying dispersion, it is particularly preferred to use two or more emulsifying apparatus in combination, e.g., by the method of using the high pressure homogenizer after emulsification by a stirring-emulsifier Further, it is also preferred that after once performing emulsification dispersion with these emulsifying apparatus, additives, e.g., a wetting agent and a surfactant, are added to the composition, and then the composition is passed again through the high pressure homogenizer while charging a cartridge with the ink composition.

When a low boiling point organic solvent is contained in the ink composition in addition to the oil-soluble dye and the monomer of the present invention in emulsification dispersion, it is preferred to substantially eliminate the low boiling point organic solvent from the stability of the emulsified substance and the safety and hygienic point of view.

For substantially eliminate low boiling point organic solvents, various methods can be used according to the kinds of low boiling point organic solvents, e.g. evaporation, vacuum evaporation and ultrafiltration can be used. It is preferred to eliminate low boiling point organic solvents as soon as possible after emulsification.

Various surfactants can be used in the emulsification dispersion. For example, anionic surfactants, such as fatty acid salt, alkylsulfate, alkylbenzenesulfonate, alkyl-naphthalenesulfonate, dialkylsulfosuccinate, alkylphosphate, condensation product of naphthalenesulfonic acid and formalin, and polyoxyethylene alkylsulfate, nonionic surfactants, such as polyoxyethylenealkyl ether, polyoxyethylenealkylaryl ether, polyoxyethylene fatty acid ester, sorbitan fatty acid ester, polyoxyethylenesorbitan fatty acid ester, polyoxyethylenealkylamine, glycerol fatty acid ester, and oxyethylene-oxypropylene block copolymer, SURFYNOLS (manufactured by Air Products & Chemicals Co.) which is an acetylene series polyoxyethylene oxide surfactant, amine oxide type ampholytic surfactants, such as N,N-dimethyl-N-alkylamine oxide, and the surfactants disclosed in JP-A-59-157636, pp. 37 and 38, and Research Disclosure, No. 308119 (1989) are preferably used.

When water color ink is made by dispersing the coloring fine particles containing the oil-soluble dye and the monomer of the present invention in an aqueous medium by co-emulsifying dispersion, it is particularly important to control the particle size.

For increasing color purity and density when an image is formed by ink jet, the average particle size of the coloring fine particles in the coloring fine particle dispersion is preferably made small. Specifically, the volume average particle size of the coloring fine particles is preferably from 1 to 300 nm, more preferably from 2 to 200 nm, and still more preferably from 2 to 100 nm.

When coarse particles are present in the coloring fine particles, there are cases where the printing performances are adversely affected. For example, the nozzle of a head is clogged with coarse particles, or sometimes unevenness is caused even if the nozzle is not clogged, such that ink is jetted or not jetted due to blotting formed by coarse particles.

Accordingly, the ratio of the presence of coarse particles is preferably low. It is preferred that a particle having a particle size of 5 μm or more be 10 or less and a particle of 1 μm or more be 1,000 or less in 1 microliter of a manufactured ink.

For eliminating such coarse particles, well-known centrifugation and precise filtration can be utilized. Such separation may be performed immediately after emulsification dispersion, or may be performed after various additives, e.g., a wetting agent and a surfactant, are added to an emulsified and dispersed substance and just before putting it into an ink cartridge. It is effective to use a mechanical emulsifying apparatus to make-the average particle size of coloring fine particles small to thereby lessen coarse particles.

In the coloring fine particle dispersion in the present invention, the content of the monomer of the present invention in the coloring fine particles is not particularly restricted, but the content is preferably from 25 to 90 mass %, and more preferably from 50 to 85 mass %, from the point of good dyeing of ink into a recording paper.

Further, from the point of retaining good solubility of an oil-soluble dye, the content of the monomer of the present invention is preferably from 30 to 2,000 mass % based on the oil-soluble dye, and more preferably from 100 to 1,500 mass %.

On the other hand, when the use amount of the monomer of the present invention is too much, stable and fine dispersion is liable to be difficult due to the excess rate of an oil phase. Taking these points into consideration, the use amount of the monomer of the present invention is preferably from 50 to 1,500 mass % based on an oil-soluble dye, and more preferably from 100 to 1,000 mass %.

As a preferred embodiment of the present invention, when the coloring fine particles contain the polymerization initiator, the coloring fine particle dispersion can be manufactured by co-emulsification dispersing a solution containing at least an oil-soluble dye, the hydrophobic ethylenically unsaturated monomer and a polymerization initiator in the same manner as above. However, when the polymerization initiator is a thermal polymerization initiator, it is necessary that emulsification dispersion and the desolvation of low boiling point organic solvent be carried out at low temperature, and the temperature is preferably 40° C. or less, and particularly preferably 30° C. or less.

A polymerization initiator may be directly added to a coloring fine particle dispersion obtained by emulsification dispersion.

The ink composition of the present invention may further contain other components arbitrarily selected, if necessary.

Other components are contained in the range of not hindering the effect of the present invention, and well-known additives, e.g., a drying inhibitor, a permeation accelerator, an ultraviolet absorber, an oxidation preventive, an antiseptic, a pH adjustor, a surface tension adjustor, a defoaming agent, a viscosity adjustor, a dispersant, a dispersion stabilizer, a rust preventive, and a chelating agent are exemplified as other components.

The drying inhibitor is preferably used for the purpose of preventing the nozzle used in an ink jet recording system from clogging at the ink jet port due to drying of the ink composition.

Water-soluble organic solvents having lower vapor pressure than water are-preferably used as the drying inhibitor. As the specific examples of the drying inhibitors, polyhydric alcohols represented by, e.g., ethylene glycol, propylene glycol, diethylene glycol, polyethylene glycol, thiodiglycol, dithioglycol, 2-methyl-1,3-propanediol, 1,2,6-hexanetriol, acetylene glycol derivative, glycerol, and trimethylolpropane, lower alkyl ethers of polyhydric alcohols, e. g., ethylene glycol monomethyl (or ethyl) ether, diethylene glycol monomethyl (or ethyl) ether, and triethylene glycol monoethyl (or butyl) ether, heterocyclic rings, e.g., 2-pyrrolidone, N-methyl-2-pyrrolidone, 1,3-dimethyl-2-imidazolidinone, and N-ethylmorpholine, sulfur-containing compounds, e.g., sulforan, dimethyl sulfoxide, and 3-sulforen, polyfunctional compounds, e.g., diacetone alcohol and diethanolamine, and urea derivative are exemplified.

Of these compounds, polyhydric alcohols, such as glycerol and diethylene glycol, are more preferably used. These drying inhibitors may be used alone or two or more may be used in combination. It is preferred to contain these drying inhibitors in the proportion of from 10 to 50 mass % (i.e., weight %) in the ink composition.

The permeation accelerator is preferably used for the purpose of permeating the ink composition better to paper.

As the permeation accelerators, alcohols, e.g.,, ethanol, isopropanol, butanol, di (tri) ethylene glycol monobutyl ether, and 1, 2-hexanediol; sodium laurate, sodium oleate and- nonionic surfactants are exemplified.

The permeation accelerator is used in the range of not causing blurring of printed letters and print through. When the amount of from 5 to 30 mass % or so is contained in the ink composition, the permeation accelerator generally exhibits sufficient effect.

The ultraviolet absorber is used for the purpose of improving the storage stability of an image, and, e.g., the benzotriazole series compounds disclosed in JP-A-58-185677, JP-A-61-190537, JP-A-2-782, JP-A-5-197075 and JP-A-9-34057, benzophenone series compounds disclosed in JP-A-46-2784, JP-A-5-194483 and U.S. Pat. No. 3,214,463, cinnamic acid series compounds disclosed in JP-B-48-30492, JP-B-56-21141 and JP-A-10-88106, triazine series compounds disclosed in JP-A-4-298503, JP-A-8-53427, JP-A-8-239368, JP-A-10-182621 and JP-T-8-501291 (the term “JP-T” as used herein means a published Japanese translation of a PCT patent application), the compounds described in Research Disclosure, No. 24239, and compounds which absorb ultraviolet rays and emit fluorescence represented by stilbene and benzoxazole series compounds, i.e., fluorescent brightening agents, are exemplified.

The oxidation preventive is used for the purpose of improving the storage stability of an image, e.g., various organic series and metal complex series discoloration inhibitors can be used. As the organic series discoloration inhibitors, hydroquinones, alkoxyphenols, dialkoxyphenols, phenols, anilines, amines, indanes, chromans, alkoxyanilines, and heterocyclic rings are exemplified.

As the metal complex series discoloration inhibitors, nickel complexes and zinc complexes are exemplified, specifically, the compounds disclosed in the patents quoted in Research Disclosure, No. 17643, items VII-I to J, ibid., No. 15162, ibid., No. 18716, p. 650, left column, ibid., No. 36544, p. 527, ibid., No. 307105, p. 872, and ibid., No. 15162, and the compounds contained in the formulae of the representative compounds and exemplified compounds disclosed in JP-A-62-215272, pp. 127 to 137 can be used.

As the antiseptics, sodium dehydroacetate, sodium benzoate, sodium pyridinethione-1-oxide, p-hydroxyethyl-benzoate, and 1,2-benzoisothiazolin-3-one are exemplified, and they are preferably used in the proportion of from 0.02 to 1.00 mass % in the ink.

As the surface tension adjustor, nonionic, cationic and anionic surfactants are exemplified. The surface tension of the ink composition of the present invention is preferably from 25 to 70 mN/m, and more preferably from 25 to 60 mN/m.

The viscosity of the ink composition of the present invention is preferably 30 mPa.s or less, and more preferably 10 mPa.s or less.

As the defoaming agent, chelating agents represented by fluorine series and silicone series compounds and EDTA can be used, according to necessity.

The pH adjustor can be preferably used for pH adjusting of the coloring fine particles dispersed solution and providing dispersion stability, and the pH adjustor is preferably added so that pH becomes from 4.5 to 10.0, and more preferably from 6 to 10.0.

As the pH adjustors, organic bases and inorganic alkalis are preferred as the basic pH adjustor, and organic and inorganic acids are preferred as the acid pH adjustor.

In the basic pH adjustors, triethanolamine, diethanolamine, N-methyldiethanolamine and dimethylethanolamine are more preferred of the organic bases, and alkali metal hydroxide, carbonate and ammonia are more preferred of the inorganic alkalis. Of the alkali metal hydroxides, sodium hydroxide, lithium hydroxide and potassium hydroxide are particularly preferred, and of the carbonates, sodium carbonate and sodium hydrogencarbonate are particularly preferred.

In the acid pH adjustors, acetic acid, propionic acid, trifluoroacetic acid and alkylsulfonic acid are more preferred of the organic acids,. and hydrochloric acid, sulfuric acid and phosphoric acid are more preferred of the inorganic acids.

Image-forming Method:

An ink jet recording method using an ink jet printer is preferably used as the image-forming method of the present invention. In the ink jet recording method, an image is recorded on an image-receiving material by using the ink composition, and the ink nozzle used at that time is not particularly restricted and arbitrarily selected according to the purpose.

Image-receiving Material:

The image-receiving material is not particularly restricted and well-known recording materials, e.g., plain paper, resin coated paper, ink jet special paper, film, electrophotographic plain paper, dish cloth, glass, metal and ceramics are exemplified. Of the recording materials, ink jet special paper is preferred, e.g., those disclosed in JP-A-8-169172, JP-A-8-27693, JP-A-2-276670, JP-A-7-276789, JP-A-9-323475, JP-A-62-238783, JP-A-10-153989, JP-A-10-217473, JP-A-10-235995, JP-A-10-337947, JP-A-10-217597 and JP-A-10-337947 are more preferably used.

Of the image-receiving materials, the following recording paper and recording film are particularly preferred. The recording paper and the recording film comprise a support and an ink-receiving layer and, if necessary, other layers, e.g., a back coating layer, by lamination.

Each layer, including the ink-receiving layer, may comprise one layer or two or more layers.

The support comprises chemical pulp, e.g., LBKP or NBKP, mechanical pulp, e.g., GP, PGW, RMP, TMP, CTMP, CMP or CGP, or waste paper pulp, e.g., DIP, and those manufactured by various machines, such as Fourdrinier machine and cylinder machine and by adding, according to necessity, conventionally well-known pigments, binders, sizes, fixing agents, cationic agents and paper strength-increasing agents can be used. Besides these materials, synthetic paper and plastic film sheet may be used as the support.

The thickness of the support is from 10 to 250 μm or so, and the weighing capacity is preferably from 10 to 250 g/m².

The support may be provided with the ink-receiving layer, and may be further provided with the back coating layer, alternatively the ink-receiving layer and the back coating layer may be provided after size press and an anchor coat layer of starch or polyvinyl alcohol are provided.

The support may be subjected to flattening treatment by calendering apparatus such as machine calender, TG calender or soft calender.

Of the above supports, paper and plastic films both sides of which are laminated with polyolefin (e.g., polyethylene, polystyrene, polyethylene terephthalate, polybutene and copolymers of them) are preferably used.

It is more preferred to add a white pigment (e.g., titanium oxide, zinc oxide, etc.) oratintingdye (e.g., cobalt blue, ultramarine, neodymium oxide, etc.) to the polyolefin.

The ink-receiving layer contains a pigment, a aqueous binder, a mordant, a water resisting agent, a light fastness improver, a surfactant and other additives.

As the pigment, white pigments are preferably used, such as inorganic white pigments, e.g., calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide, and zinc carbonate, and organic white pigments, e.g., styrene series pigments, acrylic series pigments, urea resins and melamine resins are preferably used.

Of these white pigments, porous inorganic pigments are preferred, and synthetic amorphous silica having a great pore area is more preferred.

As the synthetic amorphous silica, both of silicic anhydride obtained by a dry producing method and moisture-containing silicic acid obtained by a wet producing method can be used, but moisture-containing silicic acid is particularly preferably used.

As the aqueous binder, water-soluble high polymers, e.g., polyvinyl alcohol, silanol-modified polyvinyl alcohol, starch, cationized starch, casein, gelatin, carboxymethyl cellulose, hydroxyethyl cellulose, polyvinylpyrrolidone, polyalkylene oxide and polyalkylene oxide derivative, and water-dispersible high polymers, e. g., styrene-butadiene latex and acrylic emulsion are exemplified.

These aqueous binders may be used alone or two or more in combination. Of these aqueous binders, polyvinyl alcohol and silanol-modified polyvinyl alcohol are preferred in the point of adhesion to the pigment and peeling resistance of the ink-receiving layer.

The mordant is preferably immobilized, and polymer mordants are preferably used for that purpose.

The polymer mordants are disclosed in various patent specifications, e.g., JP-A-48-28325, JP-A-54-74430, JP-A-54-124726, JP-A-55-22766, JP-A-55-142339, JP-A-60-23850, JP-A-60-23851, JP-A-60-23852, JP-A-60-23853, JP-A-60-57836, JP-A-60-60643, JP-A-60-118834, JP-A-60-122940, JP-A-60-122941, JP-A-60-122942, JP-A-60-235134, JP-A-1-161236, U.S. Pat. Nos. 2,484,430, 2,548,564, 3,148,061, 3,309,690, 4,115,124, 4,124,386, 4,193,800, 4,273,853, 4,282,305 and 4,450,224. The polymer mordant disclosed in JP-A-1-161236, pp. 212 to 215 is particularly preferably used. An image having excellent image quality can be obtained and light fastness of an image can be improved by the polymer mordant disclosed in JP-A-1-161236.

The water resisting agent is effective for water resistance of an image and cationic resins are preferably used. As the cationic resins, e.g., polyamidepolyamine epichlorohydrin, polyethyleneimine, polyaminesulfone, dimethyldiallylammonium chloride polymerization product and cationic polyacrylamide are exemplified, and of these, polyamidepolyamine epichlorohydrin is particularly preferred. The content of the cationic resins is preferably from 1 to 15 mass % based on all the solid contents in the ink-receiving layer, and more preferably from 3 to 10 mass %.

As the light fastness improver, zinc sulfate, zinc oxide, hindered amine series antioxidants, benzophenone series and benzotriazole series ultraviolet absorbers are exemplified, and zinc sulfate is particularly preferred.

The surfactant functions as a coating aid, a peeling improver, a sliding property improver or an antistatic agent. As the surfactant, the surfactants disclosed in JP-A-62-173463 and JP-A-62-183457 are exemplified.

An organofluoro compound may be used in place of the surfactant. The organofluoro compound is preferably hydro-phobic. Fluorine series surfactants, oily fluorine series compounds (e.g., fluorine oil), and a solid state fluorine compound resin (e.g., ethylene tetrafluoride resin) are contained in the organofluoro compound.

The organofluoro compounds are disclosed in JP-B-57-9053 (columns from 8 to 17), JP-A-61-20994 and JP-A-62-135826.

As above-described other additives, e.g., a pigment dispersant, a thickener, a defoaming agent, a dye, a fluorescent brightening agent, an antiseptic, a pH adjustor, a matting agent and a hardening agent are exemplified.

A white pigment, an aqueous binder and other components are contained in the back coating layer.

As the white pigment, white inorganic pigments, e.g., light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide, and organic pigments, e.g., styrene series plastic pigments, acrylic series plastic pigments, polyethylene, microcapsule, urea resins and melamine resins are exemplified.

As the aqueous binder, water-soluble high polymers, e.g., styrene-maleate copolymer, styrene-acrylate copolymer, polyvinyl alcohol, silanol-modified polyvinyl alcohol, starch, cationized starch, casein, gelatin, carboxymethyl cellulose, hydroxyethyl cellulose, and polyvinylpyrrolidone, and water-dispersible high polymers, e.g., styrene-butadiene latex and acrylic emulsion are exemplified.

As above-described other components, e.g., a defoaming agent, a foam inhibitor, a dye, a fluorescent brightening agent, an antiseptic and a water resisting agent are exemplified.

Polymer latexes may be added to the constituting layers of the above-described recording paper and the recording film (including the back coating layer).

The polymer latexes are used for the purpose of improving physical properties of a film, e.g., stabilization of dimension, prevention of curling, prevention of adhesion and prevention of cracking.

The polymer latexes are disclosed in JP-A-62-245258, JP-A-62-136648 and JP-A-62-110066.

When polymer latexes having a low glass transition temperature (40° C. or less) are added to the layers containing the mordant, cracking and curling of layers can be prevented. Further, when polymer latexes having a high glass transition temperature are added to the back coating layer, curling can be prevented.

In the ink jet recording method of the present invention, image-receiving materials to be used are not particularly restricted, but when a recording material comprising a support having laminated thereon an ink-receiving layer containing a white pigment is used, an image having high image quality can be obtained.

When a recording material having an ink-receiving layer containing a porous inorganic pigment such as a white pigment is used with conventional dispersed inks, most of inks are bad in dyeing into the recording paper, and the dye is peeled off from the surface when a formed image is rubbed by hand. However, as the ink of the present invention which is colored dispersion comprising an ethylenically unsaturated monomer and an oil-soluble dye is low in viscosity, oily and excellent in dyeing, such a problem has been solved. Further, when the ethylenically unsaturated monomer is subjected to polymerization after printing with the ink, the coloring fine particles convert into fine particles comprising a dye and a polymer, so that the storage stability of the image, in particular, the light fastness of the image, can be improved. Therefore, an image having high image quality, high strength and excellent in image fastness can be obtained with the recording material and the ink of the present invention.

Ink jet recording methods to be used in the present invention are not particularly restricted, and any of conventionally well-known methods, e.g., an electric charge controlling method of discharging ink by utilizing electrostatic induction, a drop-on-demand method (a pressure pulse method) by utilizing oscillation pressure of piezo elements, an acoustic ink jet method of converting electric signal into acoustic beam and irradiating ink, and jetting ink by utilizing the radiation pressure, and a thermal ink jet (bubble jet) method of heating ink to form bubbles and utilizing the generated pressure can be used. Of these methods, the drop-on-demand method (a pressure pulse method) by utilizing oscillation pressure of piezo elements is particularly preferred.

A method of jetting ink of low density called photo-ink by multi-jetting in a small volume, a method of improving an image quality by using a plurality of inks substantially the same in hue and different in densities, and a method of using colorless and transparent ink are included in the above ink jet recording methods.

### EXAMPLE

The present invention is specifically described below with referring to examples, but it should not be construed as the present invention is limited thereto.

### Example 1

Manufacture of Ink for Ink Jet Recording:

Preparation of- dispersed ink 101 of the invention:

A mixture of 2 g of Dye M-7, 1.28 g of α-sodium methyl sulfopalmitate, 4 g of pentaerythritol tetraacrylate (PET-4A), and 0.37 g of 1,1′-azobis (1-acetoxy-1-phenylethane) (OT_{AZO}-15) was dissolved in 54 g of ethyl acetate at room temperature. Into this solution was added 50 ml of deionized water, and emulsification of 10,000 rpm by a homogenizer was performed 5 cycles in total with emulsification for 4 minutes and stopping for 1 minute being 1 cycle. The thus-obtained emulsified product was concentrated under nitrogen flow until the ethyl acetate became odorless, filtered through a filter having a pore diameter of 0.45 μm, thereby a finely emulsified product of hydrophobic Dye M-7 was obtained. Diethylene glycol, glycerol, other additives and deionized water were added to the obtained emulsified product, and a magenta ink (dispersed ink 101) comprising, per 100 ml, concentration of 2 mass % of oil-soluble dye, concentration of 10 mass % of diethylene glycol, 10 mass % of glycerol, 1.0 mass % of mono-2-butyl octanoate of polyethylene glycol (average repeating number: 12) as a surfactant, 0.006 mass % of benzotriazole, and 0.2 mass % of 1,2-benzisothiazolin-3-one as an antiseptic was prepared as a final liquid. The volume average particle size of the emulsification dispersed ink was 63 nm from the measurement with Microtrack UPA (a product of Nikkiso Co., Ltd.).

Preparation of dispersed inks 102 to 111 of the invention and comparative dispersed inks 112 to-115:

Each of dispersed inks 102 to 111 of the present invention was prepared in the same manner as in the preparation of dispersed ink 101 except for changing the kind and amount of the oil-soluble dye and the kind of the polymerization initiator as shown in Table 1 below. α-Sodium methyl sulfopalmitate (dispersant) was used in the amount so as to be the same ratio to the amount of the oil-soluble components (sum total of the oil-soluble dye, monomer and polymer). The polymerization initiator was used in the amount so as to be the same mass ratio to the amount of the polymerizable ethylenically unsaturated monomer.

Further, each of comparative dispersed inks 112 to 115 was prepared in the same manner as in the preparation of dispersed ink 101 except for changing the kind and amount of the oil-soluble dye, using the high boiling point organic solvent (not having a polymerizable functional group) in place of the ethylenically unsaturated monomer, and not using the polymerization initiator. a-Sodium methyl sulfopalmitate (dispersant) was used in the amount so as to be the same ratio to the amount of the oil-soluble components (sum total of the oil-soluble dye, monomer and polymer) the same as in dispersed inks 102 to 111.

In dispersed inks 101 to 115, the concentrations of diethylene glycol, glycerol and other additives in the final inks were constant.

TABLE 1

| | | | | Concen- | | | Particle | |
|---|---|---|---|---|---|---|---|---|
| | Oil- | Monomer (or high | Oil- | tration | Dye/Monomer/ | Polymeriza- | Size of | |
| Ink | Soluble | boiling point | Soluble | of Dye | Polymer Ratio | tion | Dispersion | |
| No. | Dye | organic solvent) | Polymer | (%) | (mass %) | Initiator | (nm) | Remarks |
| 101 | M-7 | PET-4A | — | 2 | 1/2/0 | OT_{AZO}-15 | 63 | Invention |
| 102 | M-7 | PET-4A | pBMA | 2 | 1/2/0.5 | OT_{AZO}-15 | 73 | Invention |
| 103 | M-7 | TMP-3A | — | 2 | 1/2/0 | OT_{AZO}-15 | 69 | Invention |
| 104 | M-2 | PET-4A/BMA | pBMA | 2 | 1/1.5/0.5 | OT_{AZO}-15 | 70 | Invention |
| 105 | M-6 | EGDMA/t-BuAAm | — | 2 | 1/4/0 | AIBN | 69 | Invention |
| | | (2/1) | | | | | | |
| 106 | MM-1 | DPHA/BMA (1/2) | pEMA | 2 | 1/3/1 | OT_{AZO}-15 | 86 | Invention |
| 107 | C-1 | PET-4A | — | 3.5 | 1/2/0 | OT_{AZO}-15 | 75 | Invention |
| 108 | C-1 | DPHA | pSt/BA | 3.5 | 1/3/1 | V-65 | 93 | Invention |
| | | | (1/1) | | | | | |
| 109 | CC-1 | DPHA | — | 7 | 1/2/0 | OT_{AZO}-15 | 93 | Invention |
| 110 | CC-2 | TMP-3A | — | 7 | 1/2/0 | OT_{AZO}-15 | 66 | Invention |
| 111 | YY-1 | PET-4A | — | 2.7 | 1/2/0 | OT_{AZO}-15 | 89 | Invention |
| 112 | M-7 | High Boiling Point | — | 2 | 1/2/0 | — | 63 | Comparison |
| | | Organic Solvent A | | | | | | |
| 113 | M-7 | — | pBMA | 2 | 1/0/2 | — | 88 | Comparison |
| 114 | C-1 | High Boiling Point | — | 3.5 | 1/2/0 | — | 67 | Comparison |
| | | Organic Solvent A | | | | | | |
| 115 | YY-1 | High Boiling Point | — | 2.7 | 1/2/0 | — | 62 | Comparison |
| | | Organic Solvent A | | | | | | |

Note)
PET-4A: Pentaerythritol tetraacrylate
TMP-3A: Trimethylolpropane triacrylate
BMA: n-Butyl methacrylate
EGDMA: Ethylene glycol dimethacrylate
DPHA: Dipentaerythritol hexaacrylate
High boiling point organic solvent: A mixture of tricresyl phosphate/tri(2,4,4-trimethylpentyl)phosphate (3/5)
pBMA: Polybutyl methacrylate
pEMA: Polyethyl methacrylate
pSt/BA: Styrene-n-butyl methacrylate copolymer
OT_{AZO}-15: 1,1′-Azobis(1-acetoxy-1-phenylethane)
AIBN: 2,2′-Azobisisobutyronitrile
V-65: 2,2′-Azobis(2,4-dimethylvaleronitrile)

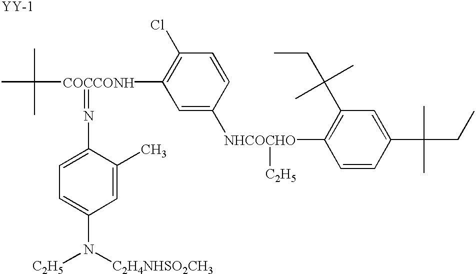

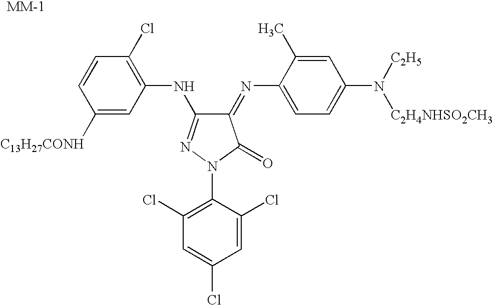

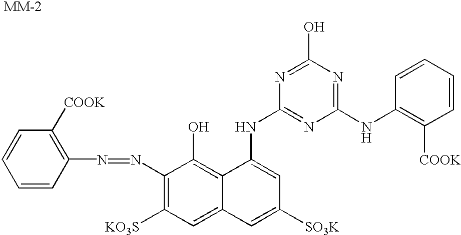

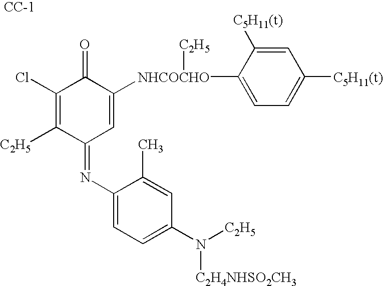

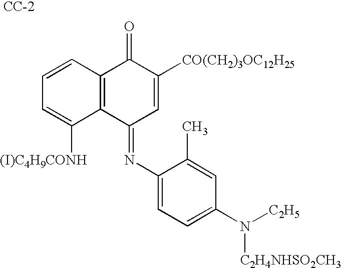

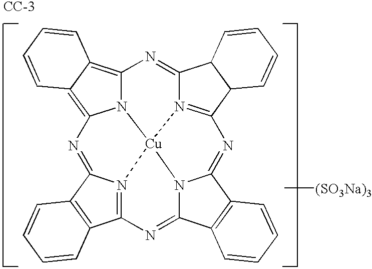

Preparation of Inks 116 and 117:

Comparative water color inks 116 and 117 for ink jet recording were prepared by mixing the following materials including a water-soluble dye and filtering the composition through a filter having a pore diameter of 0.45 μm (in ink 116, 2.8 g of magenta dye MM-2, and in ink 117, 3.5 g of dye CC-3 were used respectively).

| | |
|---|---|
| Water-soluble dye | amount shown above |
| Diethylene glycol | 10 g |
| Glycerol | 10 g |
| Diethanolamine | |
| Polyethylene glycol (average repeating number of | 1 g |
| ethylene oxide: 10) having 2-butyl octanoate at | |
| one terminal | |
| Water to make | 100 g |

The above-obtained inks 101 to 117 were all finally adjusted to pH 9 with a KOH aqueous solution.

Image Recoreing and Evaluation:

Each of the prepared inks 101 to 117 was filled into a cartridge of ink jet printer PM-670C (manufactured by ESPON Co. Ltd.), and images were recorded by using the above ink jet printer on plain paper for PPC and ink jet paper photo-glossy paper EX (manufactured by Fuji Photo Film Co., Ltd.), and then the images were subjected to heat treatment at 120° C. for 3 minutes. The obtained images were evaluated as follows. The results of evaluation are shown in Table 2 below.

Evaluation of Printing Performance:

After setting the cartridge on the printer and confirming jetting of inks from all the nozzles, images were outputted on 10 sheets of A4 size paper (29.7 cm×21 cm) and the disorder of printing was evaluated according to the following criteria.

A: Disorder of printing did not occur from start of printing to finish.

B: Disorder of printing sometimes occurred from start of printing to finish.

C: Disorder of printing occurred from start of printing to finish.

Evaluation of Paper Dependency:

The tones of images formed above on the photo-glossy paper and the plain paper for PPC were compared. Evaluation was performed according to the following three grades. The case where there was almost no difference between two images was graded A, the case where difference between two images was small was graded B, and the case where there was a great difference between two images was graded C.

Stickiness of Image:

The stickiness (i.e., the tackiness) of the recorded images was evaluated according to the following three grades. An image free of stickiness was graded A (good), an image which was a little sticky but not such a degree as soiling the object in contact was graded B (allowable), and a sticky image was graded C (bad).

Evaluation of Abrasion Resistance:

An image aged 30 minutes after printing and heating was rubbed with an eraser and the change of density was visually evaluated. An image on which density change was hardly observed was graded A (good), and an image on which density change was observed was graded B (bad).

Evaluation of Water Resistance:

The above photo-glossy paper having formed thereon an image was dried at room temperature for 1 hour, soaked in water for 30 seconds, spontaneously dried at room temperature and bleeding was observed. Bleeding of the recorded images was evaluated according to the following three grades. An image free of bleeding was graded A, an image which generated slight bleeding was graded B, and an image which generated considerable bleeding was graded C.

Evaluation of Light Fastness:

The above photo-glossy paper having formed thereon an image was subjected to irradiation with xenon (85,000 lx) through a filter of 366 nm for 10 days, and the image densities before and after irradiation were measured with a reflection densitometer (X-Rite 310 TR). The light fastness was evaluated as the surviving rate of dye according to the following three grades. An image showing the surviving rate of dye of 85% or more was graded A, from 70% to less than 85% was graded B, and less than 70% was graded C.

TABLE 2

| Ink | Printing | Paper | | Abrasion | Water | Light | |
|---|---|---|---|---|---|---|---|
| No. | Performance | Dependency | Stickiness | Resistance | Resistance | Fastness | Remarks |
| 101 | A | A | A | A | A | A | Invention |
| 102 | A | A | A | A | A | A | Invention |
| 103 | A | A | A | A | A | A | Invention |
| 104 | A | A | A | A | A | A | Invention |
| 105 | A | A | A | A | A | A | Invention |
| 106 | A | A | A | A | A | A | Invention |
| 107 | A | A | A | A | A | A | Invention |
| 108 | A | A | A | A | A | A | Invention |
| 109 | A | A | A | A | A | A | Invention |
| 110 | A | A | A | A | A | A | Invention |
| 111 | A | A | A | A | A | A | Invention |
| 112 | A | A | A | A | A | B | Comparison |
| 113 | A | A | A | B | A | A | Comparison |
| 114 | A | A | A | A | A | B | Comparison |
| 115 | A | A | A | A | A | B | Comparison |
| 116 | A | B | A | A | C | C | Comparison |
| 117 | A | B | A | A | C | B | Comparison |

As is apparent from the results in Table 2, the inks for ink jet recording of the present invention were excellent in printing performance and the physical strength of images, free of paper dependency and stickiness and excellent in water resistance and light fastness, in particular, the light fastness was conspicuously improved.

Further, when the dyes represented by formula (II) or (III), which were the particularly preferred dyes of the dyes represented by formula (I) used in inks 101 to 105, 107 and 108, were used, images extremely excellent also in tone were obtained.

### Example 2

The following ink set was prepared and a full color image was recorded. Evaluations were performed in the same manner as in Example 1.

<Magenta Ink>

Ink 101 described in Example 1 was used as it was.

<Light magenta ink>

Ink having the same constitution with ink 101 was prepared except that the amount of the coloring fine particles was reduced so that the concentration of the coloring fine particle dispersion in ink 101 became 1/4.

<Cyan Ink>

Ink 107 described in Example 1 was used as it was.

<Light Cyan ink>

Ink having the same constitution with ink 107 was prepared except that the amount of the coloring fine particles was reduced so that the concentration of the coloring fine particle dispersion in ink 107 became 1/4.

<Yellow Ink>

Ink 111 described in Example 1 was used as it was.

<Black Ink>

Black ink was prepared in the same manner as in the preparation of magenta ink 101 above except for changing 2 g of Dye M-7 used in the preparation of ink 101 to 1 g of Dye M-7, 3.5 of Dye C-1 and 1.35 g of YY-1.

Image Recording and Evaluation:

Ink set prepared was evaluated in the same manner as in Example 1. Drying property and bleeding of fine line were evaluated as follows.

Evaluation of Drying Property:

Just after image printing, the image part was touched by finger and the attached blotting was visually evaluated.

Evaluation of Bleeding of Fine Line:

Fine line patterns of yellow, magenta, cyan and black were printed and bleeding was visually evaluated.

As a result of the printing test of the ink set, similarly to Example 1, the inks of the present invention were excellent in all of printing performance, physical strength of images, tone (paper dependency), water resistance and light fastness.

### Example 3

Manufacture of Ink for Ink Jet Recording:

Preparation of dispersed ink 301 of the invention:

Dispersed ink 301 was prepared by the same method as in the preparation of dispersed ink 101 except for using 0.17 g of bis (2,6-dimethoxybenzoyl) -2,4,4-trimethylpentyl phosphine oxide and 0.07 g of 1-hydroxycyclohexyl phenyl ketone in place of the polymerization initiator used in dispersed ink 101, and 0.04 g of tetraethylenepentamine as a polymerization accelerator.

Preparation of Dispersed Inks 302 to 311 of the Invention:

Dispersed inks 302 to 311 of the present invention were prepared in the same manner as in the preparation of dispersed ink 301 except for changing the kinds and amounts of the polymerization initiator as shown in Table 3 below. α-Sodium methyl sulfopalmitate (dispersant) was used in the amount so as to be the same ratio to the amount of the oil-soluble components (sum total of the oil-soluble dye, monomer and polymer). The polymerization initiator was used in the amount so as to be the same mass ratio to the amount of the polymerizable ethylenically unsaturated monomer.

TABLE 3

| | Oil- | Monomer (or high | Oil- | Concen- | Dye/Monomer/ | Polymeri- | Particle | |
|---|---|---|---|---|---|---|---|---|
| Ink | Soluble | boiling point | Soluble | tration | Polymer Ratio | zation | Size of | |
| No. | Dye | organic solvent) | Polymer | of Dye (%) | (mass %) | Initiator | Dispersion (nm) | Remarks |
| 301 | M-7 | PET-4A | — | 2 | 1/2/0 | I-1 | 65 | Invention |
| 302 | M-7 | PET-4A | pBMA | 2 | 1/2/0.5 | I-1 | 70 | Invention |
| 303 | M-9 | TMP-3A | — | 2 | 1/2/0 | 1-3 | 63 | Invention |
| 304 | M-2 | PET-4A/EGDMA | pBMA | 2 | 1/1.5/0.5 | I-1 | 70 | Invention |
| 305 | M-6 | EGDMA/t-BuAAm | — | 2 | 1/4/0 | 1-2 | 72 | Invention |
| | | (2/1) | | | | | | |
| 306 | MM-1 | DPHA/EMA (1/2) | PEMA | 2 | 1/3/1 | I-1 | 84 | Invention |
| 307 | C-1 | PET-4A | — | 3.5 | 1/2/0 | I-1 | 83 | Invention |
| 308 | C-1 | DPHA/2-EHA | pSt/BA | 3.5 | 1/3/1 | 1-3 | 88 | Invention |
| | | | (1/1) | | | | | |
| 309 | CC-1 | DPHA | 7 | 1/2/0 | 1-2 | 86 | Invention | |
| 310 | CC-2 | TMP-3A | — | 7 | 1/2/0 | I-1 | 76 | Invention |
| 311 | YY-1 | PET-4A | — | 2.7 | 1/2/0 | I-1 | 81 | Invention |

Note)
Initiators:
I-1: A mixture of bis (2,6-dimethoxybenzoyl)-2,4,4-trimethylpentylphosphine oxide/1-hydroxy chlorophenyl ketone (7/3)
I-2: 1-Hydroxy chiorophenyl ketone
I-3: 1,1-Dimethoxy-1-phenylacetone
2-EHA: 2-Ethylhexyl acrylate
Other abbreviations are the same as in Table 1.

Image Recording and Evaluation:

Each of the prepared inks 301 to 311 and comparative inks 112 to 117 used in Example 1 was filled into a cartridge of ink jet printer PM-670C (manufactured by EPSON Co. Ltd.), and images were recorded by using the above ink jet printer on plain paper for PPC and ink jet paper photo-glossy paper EX (manufactured by Fuji Photo Film Co., Ltd.), and then the images were subjected to exposure treatment by exposure amount of 700 mJ/cm² with a metal halide lamp. The obtained images were evaluated in the same manner as in Example 1. The results of evaluation are shown in Table 4 below.

TABLE 4

| Ink | Printing | Paper | | Abrasion | Water | Light | |
|---|---|---|---|---|---|---|---|
| No. | Performance | Dependency | Stickiness | Resistance | Resistance | Fastness | Remarks |
| 301 | A | A | A | A | A | A | Invention |
| 302 | A | A | A | A | A | A | Invention |
| 303 | A | A | A | A | A | A | Invention |
| 304 | A | A | A | A | A | A | Invention |
| 305 | A | A | A | A | A | A | Invention |
| 306 | A | A | A | A | A | A | Invention |
| 307 | A | A | A | A | A | A | Invention |
| 308 | A | A | A | A | A | A | Invention |
| 309 | A | A | A | A | A | A | Invention |
| 310 | A | A | A | A | A | A | Invention |
| 311 | A | A | A | A | A | A | Invention |
| 112 | A | A | ~A | A | A | B | Comparison |
| 113 | A | A | A | B | A | A | Comparison |
| 114 | A | A | A | A | A | B | Comparison |
| 115 | A | A | A | A | A | B | Comparison |
| 116 | A | B | A | A | C | C | Comparison |
| 117 | A | B | A | A | C | B | Comparison |

The inks for ink jet recording of the present invention were excellent in printing performance and the physical strength of images, free of paper dependency and stickiness and excellent in water resistance and light fastness even in the system of using the UV curing type polymerization initiator. In particular, the light fastness was conspicuously improved. Further, similarly to Example 1, when the dyes represented by formula (II) or (III), which were the particularly preferred dyes of the dyes represented by formula (I) used in inks 301 to 305, 307 and 308, were used, images extremely excellent also in tone were obtained.

### Example 4

The following ink set was prepared and a full color image was recorded. Evaluations were performed in the same manner as in Example 3.

<Magenta Ink>

Ink 301 described in Example 3 was used as it was.

<Light Magenta Ink>

Ink having the same constitution with ink 301 was prepared except that the amount of the coloring fine particles was reduced so that the concentration of the coloring fine particle dispersion in ink 301 became 1/4.

<Cyan Ink>

Ink 307 described in Example 3 was used as it was.

<Light Cyan ink>

Ink having the same constitution with ink 307 was prepared except that the amount of the coloring fine particles was reduced so that the concentration of the coloring fine particle dispersion in ink 307 became 1/4.

<Yellow Ink>

Ink 311 described in Example 3 was used as it was.

<Black Ink>

Black ink was prepared in the same manner as in the preparation of magenta ink 301 above except for changing 2 g of Dye M-7 used in the preparation of ink 301 to 1 g of Dye M-7, 3.5 of Dye C-1 and 1.35 g of YY-1.

Image Recording and Evaluation:

Ink set prepared was evaluated in the same manner as in Example 2.

As a result of the printing test of the ink set, similarly to Example 3, the inks of the present invention were excellent in all of printing performance, physical strength of images, tone (paper dependency), water resistance and light fastness.

### Example 5

Printing was performed by using dispersed inks 101 to 111, 301 to 311 and comparative inks 112 to 117 and by replacing the materials to be recorded (supports) with electrophotographic paper, plain paper (copying paper of general use), polyester film (paper for OHP) and aluminum deposited film (printing was performed on the aluminum side). It was shown that the inks of the present invention had excellent printing performance, water resistance and light fastness the same as in the above Examples. In particular, in printing on the polyester film and the aluminum deposited film as the materials to be recorded, conventional water color inks were inferior in water resistance, solvent dispersed ink showed stickiness, and polymer dispersed ink was extremely inferior in abrasion resistance. On the other hand, the inks of the present invention provided images free of stickiness (i.e., tackiness) and peeling off by rubbing with fingers, and excellent in water resistance, solvent resistance and light fastness with lower energy exposure (200 mJ/cm² or less).

### EFFECT OF THE INVENTION

The ink compositions of the present invention are excellent in tone (free of paper dependency) and water resistance. Further, it is possible to effect polymerization by the application of low energy in the image-forming method using the ink composition of the present invention, and images excellent in particular in light fastness and physical strength (e.g., abrasion resistance) can be obtained according to the present invention.

The entitle disclosure of each and every foreign patent application from which the benefit of foreign priority has been claimed in the present application is incorporated herein by reference, as if fully set forth herein.

While the invention has been described in detail and with reference to specific examples thereof, it will be apparent to one skilled in the art that various changes and modifications can be made therein without departing from the spirit and scope thereof.

What is claimed is:

1. An ink composition comprising an aqueous medium having dispersed therein a coloring fine particle dispersion, wherein the coloring fine particle dispersion contains a hydrophobic ethylenically unsaturated monomer and at least one oil-soluble dye, and the ink composition contains a polymerization initiator.

2. An image-forming method comprising the steps of: printing by using the ink composition comprising an aqueous medium having dispersed therein a coloring fine particle dispersion in which the coloring fine particle dispersion contains a hydrophobic ethylenically unsaturated monomer and at least one oil-soluble dye, and the ink composition contains a polymerization initiator; and then polymerizing the hydrophobic ethylenically unsaturated monomer.

3. A manufacturing method of the ink composition comprising an aqueous medium having dispersed therein a coloring fine particle dispersion in which the coloring fine particle dispersion contains a hydrophobic ethylenically unsaturated monomer and at least one oil-soluble dye, and the ink composition contains a polymerization initiator; wherein the method comprises the step of obtaining the coloring fine particle dispersion by emulsification of a solution containing the hydrophobic ethylenically unsaturated monomer and at least one oil-soluble dye in the aqueous dispersion.

4. The ink composition as claimed in claim 1, wherein the oil-soluble dye is represented by the following formula (I): 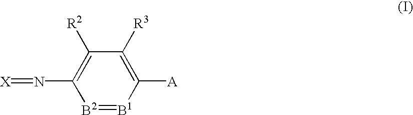
wherein X represents the residue of a color photographic coupler; A represents —NR⁴R⁵ or a hydroxyl group; R⁴ and R⁵ each represents a hydrogen atom, an aliphatic group, an aromatic group, or a heterocyclic group; B¹ represents ═C (R⁶)—or ═N—; B² represents —C(R⁷)═or —N═; R², R³, R⁶ and R⁷ each represents a hydrogen atom, a halogen atom, an aliphatic group, an aromatic group, a heterocyclic group, a cyano group, —OR⁵¹, —SR⁵², —CO₂R⁵³, —OCOR⁵⁴, —NR R⁵⁵R⁵⁶, —CONR⁷⁵R⁵⁸, —SO₂R⁵⁹, —SO₂NR⁶⁰R⁶¹, —NR⁶²CONR⁶³R⁶⁴, NR⁶⁵CO₂R⁶⁶, —COR⁶⁷, —NR⁶⁸COR⁶⁹ or —NR⁷⁰SO₂R⁷¹; R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸, R⁶⁹, R⁷⁰ and R⁷¹ each represents a hydrogen atom, an aliphatic group or an aromatic group; and R² and R³, R³ and R⁴, R⁴ and R5, R⁵ and R⁶ and R⁶ and R ⁷may be bonded to each other to form a ring.

5. The ink composition as claimed in claim 1, wherein the content of the hydrophobic ethylenically unsaturated monomer in the coloring fine particles is 25 mass % or more.

6. The ink composition as claimed in claim 1, wherein the polymerization initiator is contained in the coloring fine particles.

7. The ink composition as claimed in claim 1, wherein the polymerization initiator is an initiator which generates radicals by heating or ultraviolet irradiation.

8. The ink composition as claimed in claim 1, wherein the boiling point of the hydrophobic ethylenically unsaturated monomer is 150° C. or higher.

9. The ink composition as claimed in claim 1, wherein the average particle diameter of the coloring fine particles in the coloring fine particle dispersion is 500 nm or less.

10. The ink composition as claimed in claim 1, which: has viscosity of 10 mPa.s or less.

11. The image-forming method as claimed in claim 2, wherein the ink composition is used for recording on the image-receiving material comprising a support having thereon an ink-receiving layer containing a porous inorganic pigment.
